(19) United States
(12) Patent Application Publication
(10) Pub. No.: US 2025/0275012 A1
(43) Pub. Date: Aug. 28, 2025

(54) METHOD AND DEVICE FOR TRANSMITTING AND RECEIVING CONFIGURATION INFORMATION

(71) Applicant: Samsung Electronics Co., Ltd., Suwon-si, Gyeonggi-do (KR)

(72) Inventors: Weiwei WANG, Beijing (CN); Lixiang XU, Beijing (CN); Hong WANG, Beijing (CN)

(21) Appl. No.: 18/859,344

(22) PCT Filed: Apr. 26, 2023
(86) PCT No.: PCT/KR2023/095020

§ 371 Date: Oct. 23, 2024

(30) Foreign Application Priority Data
Apr. 27, 2022 (CN) 202210458152.0
Nov. 4, 2022 (CN) 202211379765.1

(51) Int. Cl. H04W 76/28; H04L 47/283

(52) U.S. Cl. CPC H04W 76/28; H04L 47/283

(57) ABSTRACT

The disclosure relates to a 5G or 6G communication system for supporting a higher data transmission rate. The present application discloses a method and device in a wireless communication system. According to one aspect of the present disclosure. there is provided a method performed by a first node in a wireless communication system, the method comprising: receiving, from a second node, a first message determined based on service features of the first node, wherein the first message comprises information related to the service features of the first node; and performing reception and transmission of data and/or signal based on the first message.

### TECHNICAL FIELD

The present application relates to wireless communication technologies, and in particular, to a method and device for transmitting and receiving configuration information.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

With the gradual maturity of 5G commercial network (NR: New Radio access network), various emerging 5G network-based services have been launched. Among these services, Extended Reality (XR) service is considered a typical application in the 5G era. Extended Reality services comprises Augmented Reality (AR), Virtual Reality (VR) and Mixed Reality (MR). It is widely known that, the XR service involves a large amount of data and has a high requirement for latency and reliability. Therefore, this sets higher requirements for the NR network. The research and standardization of the 5G network service with respect to XR service is also underway.

### Solution to Problem

According to one aspect of the present disclosure, there is provided a method performed by a first node in a wireless communication system, the method comprising: receiving a first message from a second node, wherein the first message is determined based on information related to service features of the first node; and performing reception and transmission of data and/or signal based on the first message.

In various embodiments, the first message comprises at least one of the following information: first number information for indicating a system frame number; second number information, which indicates the number information of a reference system frame; transmission period information, which is used to indicate period-related information related to the first node performing the reception and transmission of data and/or signal; first information, which is used to indicate configuration information related to the first node performing the reception and transmission of data and/or signal; third configuration information, which is used to indicate configuration information related to the first node performing Physical Downlink Control Channel (PDCCH) monitoring; first timer information, which is used to indicate configuration information related to a first timer, the first timer being a time when the first node performs the reception and transmission of data and/or signal or a time of switching the configuration; second timer information, which is used to indicate configuration information related to a second timer, the second timer being the time using the configuration when the first node performs the reception and transmission of data and/or signal; and configuration information for Discontinuous Reception (DRX), which is used to indicate configuration information related to the first node performing the DRX.

In various embodiments, the transmission period information comprises at least one of the following information: first period information, which is used to indicate information related to a first period, the first period being a period corresponding to the first node performing the reception and transmission of data and/or signal; first offset information, which is used to indicate offset information related to the first period; second period information, which is used to indicate information related to a second period used within the first period; and second offset information, which is used to indicate offset information related to the second period.

In various embodiments, the first information comprises at least one of the following information: signal monitoring configuration information, which is used to indicate configuration information related to monitoring a signal; trigger indication information, which is used to indicate a time when the first node triggers and/or starts reception and transmission of data and/or signal configured by the signal monitoring configuration information; and trigger timer information, which is used to indicate a timer related to triggering and/or starting reception and transmission of data and/or signal configured by the signal monitoring configuration information.

In various embodiments, the third configuration information comprises multiple sets of configuration information, wherein each set of configuration information comprises at least one of the following information: an offset time for monitoring start; a time length for monitoring; and first state indication information, which is used to indicate whether the set of configuration information is in an active state; and/or the third configuration information comprises second state indication information, which indicates whether one or more sets of configuration information in the multiple sets of configuration information are in an active state(s).

In various embodiments, the first timer information comprises one or more configurations for length information, and for each configuration of length information, the first timer information comprises at least one of the following information: first timer length information; first condition information, which is used to indicate condition information related to starting or restarting the first timer; decrement step size information, which is used to indicate information related to decrement of a timer initial length set when starting or restarting the first timer and/or a step size of a timer when decrementing; first applicability information, which is used to indicate information related to an applicable scope(s) of one or more pieces of information included in the first timer information; and third state indication information, which is used to indicate whether a configuration for the length information is in an active state; and/or the first timer information comprises fourth state indication information, which is used to indicate whether one or more sets of configurations for length information among multiple sets of configurations for length information are in an active state(s); and/or the second timer information comprises at least one of the following information: second timer length information; second applicability information, which is used to indicate information related to an applicable scope(s) of one or more pieces of information included in the second timer information; and state indication information, which is used to indicate whether the second timer information is in an active state.

In various embodiments, the configuration information for DRX comprises one or more sets of DRX-related configuration information, and each set of DRX-related configuration information comprises at least one of the following information: first configured DRX information, comprising a configuration of parameters for performing DRX; applicable scope information, which indicates an applicable scope of the first configured DRX information; fifth state indication information, which is used to indicate whether the set of configuration is in an active state; and default configuration indication information, which indicates whether the first configured DRX information is a default configuration, and/or the DRX configuration information comprises sixth state indication information, which indicates whether one or more sets of DRX-related configuration information among multiple sets of DRX-related configuration information are in an active state(s).

In various embodiments, the first node receives a second message from the second node, wherein the second message comprises information related to service features of the first node; wherein performing the reception and transmission of data and/or signal based on the first message comprises: the first node performing the reception and transmission of data and/or signal based on the first message and the second message.

In various embodiments, the second message comprises at least one of the following information: first start indication information, which is used to indicate whether the first node starts a configuration related to a specific search space; first stop indication information, which is used to indicate whether the first node stops the reception and transmission of data and/or signal; first time indication information, which is used to indicate information related to the first node starting or restarting a timer; second time indication information, which is used to indicate information related to the first node starting or restarting a plurality of timers; first configuration indication information, which is used to indicate a configuration related to the first node performing the DRX; and second configuration indication information, which is used to indicate a configuration related to the first node performing the PDCCH monitoring.

In one embodiment, the method further comprises: the first node transmitting to the second node at least one of information related to service features of the first node and configuration information that the first node expects regarding the reception and transmission of data and/or signal.

In various embodiments, the signal comprises at least one of a PDCCH, a wake-up signal (WUS), and a paging early indication (PEI) signal.

According to another aspect of the present disclosure, there is provided a node device in a wireless communication system, comprising: a transceiver; and a processor coupled to the transceiver and configured to perform the above method.

According to another aspect of the present disclosure, there is provided a method performed by a second node in a wireless communication system, comprising: determining a first message based on information related to service features of a first node; and transmitting the first message to the first node.

In various embodiments, the first message comprises at least one of the following information: transmission period information, which is used to indicate period-related information related to the first node performing the reception and transmission of data and/or signal; first information, which is used to indicate configuration information related to the first node performing the reception and transmission of data and/or signal; third configuration information, which is used to indicate configuration information related to the first node performing PDCCH monitoring; first timer information, which is used to indicate configuration information related to a first timer, the first timer being the time when the first node performs the reception and transmission of data and/or signal or the time of switching the configuration; second timer information, which is used to indicate configuration information related to a second timer, the second timer being the time using the configuration when the first node performs the reception and transmission of data and/or signal; and configuration information for DRX, which is used to indicate configuration information related to the first node performing the DRX.

In various embodiments, the transmission period information comprises at least one of the following information: first period information, which is used to indicate information related to a first period, the first period being a period corresponding to the first node performing the reception and transmission of data and/or signal; first offset information, which is used to indicate offset information related to the first period; second period information, which is used to indicate information related to a second period used within the first period; and second offset information, which is used to indicate offset information related to the second period.

In various embodiments, the first information comprises at least one of the following information: signal monitoring configuration information, which is used to indicate configuration information related to monitoring a signal; trigger indication information, which is used to indicate a time when the first node triggers and/or starts reception and transmission of data and/or signal configured by the signal monitoring configuration information; and trigger timer information, which is used to indicate a timer related to triggering and/or starting reception and transmission of data and/or signal configured by the signal monitoring configuration information.

In various embodiments, the third configuration information comprises multiple sets of configuration information, wherein each set of configuration information comprises at least one of the following information: an offset time for monitoring start; a time length for monitoring; and first state indication information, which is used to indicate whether the set of configuration information is in an active state; and/or the third configuration information comprises second state indication information, which indicates whether one or more sets of configuration information in the multiple sets of configuration information are in an active state(s).

In various embodiments, the first timer information comprises one or more configurations for length information, and for each configuration of length information, the first timer information comprises at least one of the following information: first timer length information; first condition information, which is used to indicate condition information related to starting or restarting the first timer; decrement step size information, which is used to indicate information related to decrement of a timer initial length set when starting or restarting the first timer and/or a step size of a timer when decrementing; first applicability information, which is used to indicate information related to an applicable scope(s) of one or more pieces of information included in the first timer information; and third state indication information, which is used to indicate whether a configuration for the length information is in an active state; and/or the first timer information comprises fourth state indication information, which is used to indicate whether one or more sets of configurations for length information among multiple sets of configurations for length information are in an active state(s); and/or the second timer information comprises at least one of the following information: second timer length information; second applicability information, which is used to indicate information related to an applicable scope(s) of one or more pieces of information included in the second timer information; and state indication information, which is used to indicate whether the second timer information is in an active state.

In various embodiments, the configuration information for DRX comprises one or more sets of DRX-related configuration information, and each set of DRX-related configuration information comprises at least one of the following information: first configured DRX information, comprising a configuration of parameters for performing DRX; applicable scope information, which indicates an applicable scope of the first configured DRX information; fifth state indication information, which is used to indicate whether the set of configuration is in an active state; and default configuration indication information, which indicates whether the first configured DRX information is a default configuration, and/or the DRX configuration information comprises sixth state indication information, which indicates whether one or more sets of DRX-related configuration information among multiple sets of DRX-related configuration information are in an active state(s).

In a further embodiment, the method further comprises: receiving information related to the service features of the first node from a core network device or a user equipment;

In a further embodiment, the method further comprises: determining a second message based on information related to the service features of the first node; and transmitting the second message to the first node.

In various embodiments, the second message comprises at least one of the following information: first starting indication information, which is used to indicate whether the first node starts a configuration related to a specific search space; first stop indication information, which is used to indicate whether the first node stops the reception and transmission of data and/or signal; first time indication information, which is used to indicate information related to the first node starting or restarting a timer; second time indication information, which is used to indicate information related to the first node starting or restarting a plurality of timers; first configuration indication information, which is used to indicate a configuration related to the first node performing the DRX; and second configuration indication information, which is used to indicate a configuration related to the first node performing the PDCCH monitoring.

In a further embodiment, the method further comprises receiving, from the first node, configuration information that the first node expects regarding the reception and transmission of data and/or signal.

In various embodiments, the signal comprises a PDCCH or a wake-up signal (WUS) or a paging early indication (PEI) signal.

According to another aspect of the present disclosure, there is provided a node device in a wireless communication system, comprising: a transceiver configured to transmit and receive a signal; and a controller coupled to the transceiver and configured to perform operations in the above method.

In various embodiments, the node device is a base station or a centralized unit user plane CU-UP node of a base station or a centralized unit control plane CU-CP node of the base station.

According to another aspect of the present disclosure, there is provided a method performed by a fourth node in a wireless communication system, comprising: determining an assistant message based on information related to service features of a first node; and transmitting the assistant message to a fifth node.

In a further embodiment, the method further comprises: the fourth node receiving the information related to the service features of the first node from a core network device or a user equipment or a centralized unit user plane CU-UP of a base station.

In various embodiments, the fourth node is a centralized unit of a base station or a centralized unit control plane CU-CP of the base station, and the fifth node is a distributed unit DU of the base station or a centralized unit user plane CU-UP of the base station.

According to another aspect of the present disclosure, there is provided a method performed by a fifth node in a wireless communication system, comprising: receiving an assistant message from a fourth node, the assistant message being determined based on information related to service features of a first node; performing reception and transmission of data and/or signal with the first node based on an assistant message related to service features of a user equipment; and/or determining a first message and/or a second message based on the assistant message related to the service features of the user equipment and transmitting the first message and/or the second message is to the first node.

According to another aspect of the present disclosure, there is provided a node device in a wireless communication system, comprising: a transceiver configured to transmit and receive a signal; and a controller coupled to the transceiver and configured to perform a method as follows: determining an assistant message based on information related to service features of a first node; and transmitting the assistant message to a fifth node.

In a further embodiment, the node device receives the information related to the service features of the first node from a core network device or a user equipment or a centralized unit user plane CU-UP of a base station.

In a further embodiment, the node device is a centralized unit of a base station or a centralized unit control plane CU-CP of the base station, and the fifth node is a distributed unit DU of the base station or a centralized unit user plane CU-UP of the base station.

According to another aspect of the present disclosure, there is provided a node device in a wireless communication system, comprising: a transceiver configured to transmit and receive a signal; and a controller coupled to the transceiver and configured to perform a method as follows: receiving an assistant message from a fourth node, the assistant message being determined based on information related to service features of a first node; performing reception and transmission of data and/or signal with the first node based on an assistant message related to service features of a user equipment; and/or determining a first message and/or a second message based on the assistant message related to the service features of the user equipment and transmitting the first message and/or the second message is to the first node.

### Advantageous Effects of Invention

The present application provides a method and a device for transmitting and receiving configuration information.

### BRIEF DESCRIPTION OF DRAWINGS

FIG. 1 is a schematic diagram of an architecture of 5G;

FIG. 2 is an example of a base station structure;

FIG. 3 is an example of a configuration process according to an embodiment of the present disclosure;

FIG. 4 is an example of a period configuration according to an embodiment of the present disclosure;

FIG. 5 is an example of a main configuration according to an embodiment of the present disclosure;

FIG. 6A is an example of updating a timer according to an embodiment of the present disclosure;

FIG. 6B is an example of updating a timer according to an embodiment of the present disclosure;

FIG. 7A is an example of restarting a timer according to an embodiment of the present disclosure;

FIG. 7B is an example of restarting a timer according to an embodiment of the present disclosure;

FIG. 8 is a first example of a network-side process according to an embodiment of the present disclosure;

FIG. 9 is a second example of a network-side process according to an embodiment of the present disclosure; and

FIG. 10 is a third example of a network-side process according to an embodiment of the present disclosure; and

FIG. 11 is a schematic diagram of a method performed by a first node according to an embodiment of the present disclosure.

FIG. 12 is a schematic diagram of a user equipment (UE) according to an embodiment of the disclosure.

FIG. 13 is a schematic diagram of a network according to an embodiment of the disclosure.

### MODE FOR THE INVENTION

In order to make the objectives, solutions and advantages of the embodiments of the present disclosure more clear, the solutions of the embodiments of the present disclosure will be clearly and completely described below with reference to the accompanying drawings of the embodiments of the present disclosure. Obviously, the described embodiments are some, but not all, of the embodiments of the present disclosure. Based on the described embodiments of the present disclosure, all other embodiments obtained by persons skilled in the art without creative efforts shall fall within the scope of the present disclosure.

Before undertaking the detailed description below, it may be advantageous to set forth definitions of certain words and phrases used throughout this patent document. The term “couple” and its derivatives mean any direct or indirect communication between two or more elements, whether or not those elements are in physical contact with each other. The terms “transmit”, “receive” and “communicate” and their derivatives encompass both direct and indirect communications. The terms “include” and “comprise,” as well as derivatives thereof, mean inclusion without limitation. The term “or,” is inclusive, meaning and/or. The phrase “associated with” and derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. Such a device may be implemented in hardware, firmware or software, or some combination of at least two of the same. The functionality associated with any particular controller may be centralized or distributed, whether locally or remotely. The phrase “at least one of” when used with a list of items means that different combinations of one or more of the listed items may be used, and that only one item of the list may be required. For example, “at least one of A, B, and C” comprises any of the following combinations: A, B, C, A and B, A and C, B and C, and A and B and C. For example, “at least one of A, B, or C” comprises any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The terminology used herein to describe embodiments of the invention is not intended to limit and/or define the scope of the invention. For example, unless otherwise defined, technical or scientific terms used in this disclosure should be given the ordinary meaning as understood by one of ordinary skill in the art to which this invention belongs.

It should be understood that use of “first,” “second,” and similar terms in this disclosure do not denote any order, quantity, or importance, but are merely used to distinguish the various components. Unless the context clearly dictates otherwise, the singular forms “a,” “an,” or “the” and similar words do not denote a limitation of quantity, but rather denote the presence of at least one.

As used herein, any reference to “one example” or “example”, “one embodiment” or “an embodiment” means that a particular element, feature, structure or characteristic described in connection with the embodiment is included in at least one in the examples. The appearances of the phrases “in one embodiment” or “in one example” in various places in the specification are not necessarily all referring to the same embodiment.

As used herein, “a portion” of something means “at least some” of that thing, and thus may mean less than all or all of that thing. Thus, “a part” of a thing comprises the whole thing as a special case, i.e., instances where the whole thing is a part of the thing.

It will be further understood that the terms “comprise” or “include” and similar words mean that the elements or things appearing before the word encompass the elements or things listed after the word and their equivalents, but do not exclude other elements or things. Words like “connected” or “connected” are not limited to physical or mechanical connections, but may comprise electrical connections, whether direct or indirect. “Up”, “Down”, “Left”, “Right”, etc. are only used to represent the relative positional relationship, and when the absolute position of the described object changes, the relative positional relationship may also change accordingly.

The various embodiments discussed below to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. For example, although the following detailed description of embodiments of the present disclosure will be directed to LTE and 5G communication systems, those skilled in the art will appreciate that the main points of the present disclosure may be modified slightly without substantially departing from the scope of the present disclosure. It can be applied to other communication systems with similar technical background and channel format. The solutions of the embodiments of the present application may be applied to various communication systems. For example, the communication systems may comprise a Global System for Mobile communications (GSM) system, a code division multiple access (CDMA) system, a broadband Code Division Multiple Access (WCDMA) system, General Packet Radio Service (GPRS), Long Term Evolution (LTE) system, LTE Frequency Division Duplex (FDD) system, LTE Time Division Duplex (TDD), universal mobile telecommunication system (UMTS), worldwide interoperability for microwave access (WiMAX) communication system, fifth generation (5th generation, 5G) system or new radio (NR), etc. In addition, the solutions of the embodiments of the present application may be applied to future-oriented communication technologies. In addition, the solutions of the embodiments of the present application may be applied to future-oriented communication technologies.

The following description with reference to the accompanying drawings is provided to facilitate a comprehensive understanding of various embodiments of the present disclosure as defined by the claims and their equivalents. This description comprises various specific details to facilitate understanding but should be regarded as exemplary only. Accordingly, those of ordinary skill in the art will recognize that various changes and modifications of the various embodiments described herein can be made without departing from the scope and spirit of the present disclosure. Also, descriptions of well-known functions and constructions may be omitted for clarity and conciseness.

The terms and phraseology used in the following specification and claims are not limited to their dictionary meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the scope of the present disclosure as defined by the appended claims and their equivalents.

It should be understood that the singular forms “a”, “an” and “the” include plural referents unless the context clearly dictates otherwise. Thus, for example, reference to “a component surface” comprises reference to one or more of such surfaces.

The terms “comprise” or “may comprise” refer to presence of a correspondingly disclosed function, operation, or component that may be used in various embodiments of the present disclosure, rather than excluding presence of one or more additional functions, operations, or features. Furthermore, the terms “comprise” or “have” may be interpreted to mean certain characteristics, numbers, steps, operations, constituent elements, components, or combinations thereof, but should not be interpreted as excluding one or more other characteristics, numbers, steps, operations, constituent elements, components, or the possibility of existence of a combination thereof.

The term “or” as used in various embodiments of the present disclosure comprises any of the listed terms and all combinations thereof. For example, “A or B” may comprise A, may comprise B, or may comprise both A and B.

Unless defined differently, all terms (including technical or scientific terms) used in this disclosure have the same meaning as understood by one of ordinary skill in the art described in this disclosure. Common terms as defined in dictionaries are to be interpreted to have meanings consistent with the context in the relevant technical field, and should not be interpreted ideally or overly formalized unless explicitly so defined in this disclosure.

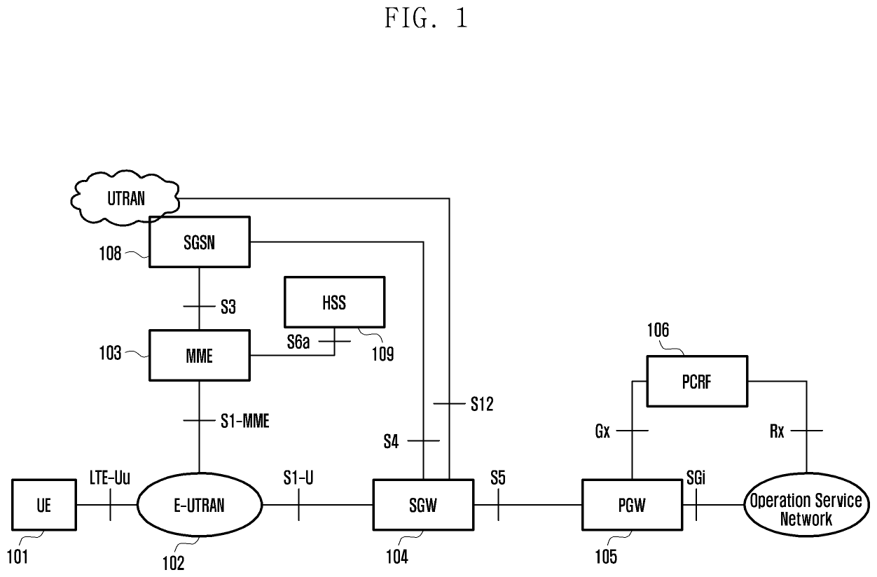

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is an exemplary system architecture 200 according to various embodiments of the present disclosure. Other embodiments of the system architecture 200 may be used without departing from the scope of this disclosure.

User Equipment (UE) 201 is a terminal device for receiving data. Next Generation Radio Access Network (NG-RAN) 202 is a radio access network that comprises base stations (gNBs or eNBs connected to the 5G core network 5GC, also called ng-gNBs) that provide UEs with access to the radio network interface. Access Control and Mobility Management Function (AMF) 203 is responsible for managing a mobility context and security information of the UE. User Plane Function (UPF) 204 mainly provides functions of a user plane. Session Management Function SMF 205 is responsible for session management. Data Network (DN) 206 comprises services by an operators, access to Internet, and third-party services and the like.

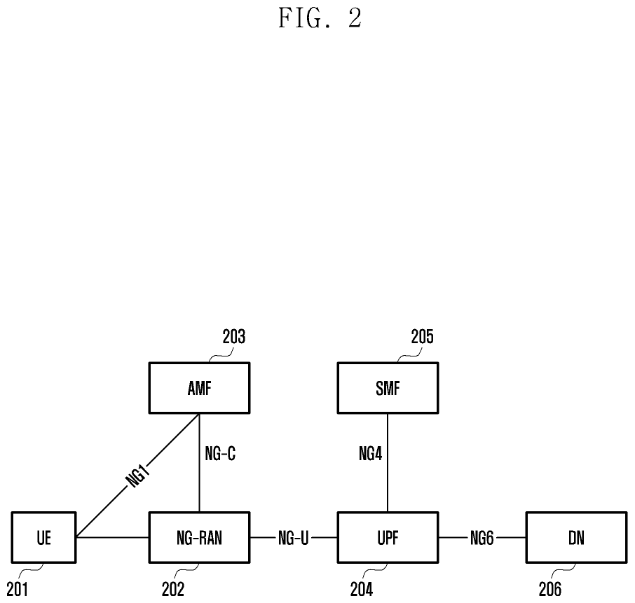

In a NR system, in order to support network function virtualization, more efficient resource management and scheduling, the base station (gNB/ng-eNB) providing the radio network interface for the terminal (UE) in NG-RAN 202 as illustrated in FIG. 2 may be further divided into a centralized unit, i.e., gNB-CU/ng-eNB-CU (gNB central unit/ng-cNB central unit) and a distributed unit, i.e., gNB-DU/ng-eNB-DU (gNB distributed unit/ng-eNB distributed unit) (referred to as CU and DU for short in this disclosure). gNB-CU has a Radio Resource Control (RRC) layer, Service Data Adaptation Protocol (SDAP) layer and Packet Data Convergence Protocol (PDCP) protocol layer, etc. and ng-eNB-CU has a RRC layer and PDCP layer. gNBDU/ng-cNB-DU has a Radio Link Control protocol (RLC), Medium Access Control (MAC) and physical layer, etc. A standardized public interface F1 is between the gNBCU and gNB-DU is, and a standardized public interface W1 is between the ngeNB-CU and ng-cNB-DU is. The F1 interface is divided into a control plane F1-C and a user plane F1-U. The transport network layer of F1-C is transmitted based on IP. In order to transmit signalling more reliably, SCTP (Stream Control Transmission Protocol) is added over IP. The protocol of the application layer is F1AP. SCTP may provide reliable application layer message transmission. The transport layer of F1-U is UDP/IP, and GTP-U is used to carry user plane protocol data unit PDU over UDP/IP. Furthermore, for gNB-CU, gNB-CU may comprise gNB-CU-CP (control plane part of centralized unit of base station) and gNB-CU-UP (user plane part of centralized unit of base station). gNB-CU-CP comprises functions of the control plane of the base station, and has RRC and PDCP protocol layers, and gNB-CU-UP comprises functions of the user plane of the base station, and has SDAP and PDCP protocol layers. Between gNB-CU-CP and gNB-CU-UP is a standardized public interface E1, and the protocol is E1AP. The interface between the control plane part of the centralized unit of the base station and the distributed unit of the base station is the F1-C interface, that is, the control plane interface of F1, and the interface between the user plane part of the centralized unit of the base station and the distributed unit of the base station is the F1-U interface, that is, the user interface of F1. In addition, in the NR system, the base station that provides the E-UTRA user plane and control plane accessing the 5G core network is referred to as ng-eNB. In order to support virtualization, this base station (ng-cNB) may also be further divided into a centralized unit ng-cNB-CU (gNB central unit/ng-cNB central unit) and a distributed unit ng-eNB-DU (gNB distributed unit/ng-cNB distributed unit) (referred to as CU and DU for short in the present invention). The ng-cNB-CU has a RRC and a PDCP layer. The gNB-DU/ng-eNB-DU has a Radio Link Control protocol (RLC) layer, a Medium Access Control (MAC) layer, a physical layer, etc. Between the ng-eNB-CU and the ng-eNB-DU is a standardized public interface W1. The W1 interface is divided into control plane W1-C and user plane W1-U. The transport network layer of W1-C is transmitted based on IP. In order to transmit signalling more reliably, SCTP protocol is added over IP. The protocol of the application layer is WIAP. The transport layer of W1-U is UDP/IP, and GTP-U is used to carry user plane Protocol Data Unit (PDU) over UDP/IP.

At present, the research of 5G network mainly focuses on how to support services of eMBB (Enhanced Mobile Broadband), URLLC (Ultra-reliable and Low Latency Communications) and eMTC (enhanced Machine-Type Communication), but the features of XR services are somewhat different from these services. For example, 1) the generation of an XR service is periodic, but due to the uncertainties of a network transmission, there is jitter in the time when the XR service arrive at the base station, and thus arrival of the XR service at base station is aperiodic; 2) an XR data packet is large, but the data packet that arrives at the base station side is not of a fixed size each time; and 3) the XR service has a high latency requirement, and the latency of data transmission will cause the deterioration of user experience, etc. Due to these special service features, the data transmission mechanism of the current NR network may not be able to adapt to the transmission of XR services. On the other hand, XR devices are some terminals that rely on battery power, which puts forward a higher requirement on the energy consumption of XR devices. At present, the energy-saving technologies of NR do not account for the features of the XR services. Therefore, the energy consumption may increase, which affects the user experience of using XR services. The technical problems mainly solved by the present invention is how to improve the energy consumption of the XR terminal and improve the user experience of using XR services. The present invention mainly relates to the following aspects:
Configuration of user equipment: how to configure communication mechanism of user equipment, such that user equipment can better adapt to needs of XR services on the basis of energy saving
Operations of user equipment: how user equipment transmits XR service according to configuration
Configuration on network side: how to configure user equipment in network device so as to cooperate with user equipment to transmit XR service

Exemplary embodiments of the present disclosure are further described below in conjunction with the accompanying drawings.

The text and figures are provided by way of example only to aid in understanding of the present disclosure. They should not be construed to limit the scope of the present disclosure in any way. While certain embodiments and examples have been provided, based on the disclosure herein, it will be apparent to those skilled in the art that the illustrated embodiments and examples may be varied without departing from the scope of the present disclosure.

Before introducing the specific content, some assumptions and some definitions of the present invention are given below.
The message names in the present invention are just examples, and other message names may also be used.
The “first”, “second”, etc. contained in the message names of the present invention are just examples of messages, and do not represent the execution order.
   In the present invention, detailed descriptions of steps unrelated to the present invention are omitted.
In the present invention, the steps in each process may be executed in combination with each other, or may be executed individually. The execution steps of each process are only examples, and other possible execution orders are not excluded.
In the present invention, a base station may be a 5G base station (such as gNB, ngcNB), a 4G base station (such as an eNB), a 6G base station, or other types of access nodes.
In the present invention, transmission of data refers to receiving or sending of the data.
In the present invention, reception and transmission of data and/or signal may refer to reception of data and/or signal, transmission of data and/or signal, or reception and transmission of data and/or signal.
In the present invention, data and signal are used interchangeably, but they have the same meaning. They may represent a physical signal, a signal on a physical channel (such as downlink control information on PDCCH, a signal on PDSCH, etc.), and data transmitted on a physical channel (such as a data packet of a upper-layer protocol (such as a MAC packet, etc.)). The “data” used herein may also be understood as “data and/or signal”, and similarly, the “signal” used herein may also be understood as “data and/or signal”.

Nodes involved in the present invention:
First node: user terminal, which in one embodiment is a terminal running an XR service
Second node: base station, or centralized unit of base station, or control plane part of centralized unit of base station, or user plane part of centralized unit of base station
Third node: distributed unit of base station, wherein the above second node transmits data of first node to third node, or the above second node transmits data of third node to first node

### First Aspect: Configuration of User Equipment

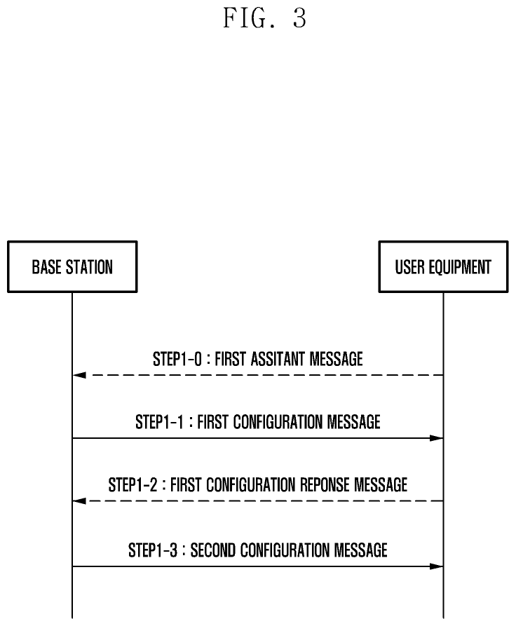

In the related art, in order to achieve energy saving of a user equipment, the network side performs some configurations on a user, such as DRX (Discontinuous Reception), configuration for PDCCH (Physical Downlink Control Channel) detection, configuration for PDCCH Skipping, which configurations may avoid the user from performing some unnecessary PDCCH detections, thereby reducing energy consumption by the user in data transmission process. However, these configurations do not well account for the features of XR services, such as aperiodicity, jitter, changes in packet size, and high latency requirements and the like. In order to solve this problem, the present invention proposes a method for configuring a user, such that the user may transmit the XR services according to the new configuration. The first aspect of the present invention comprises the following process, as shown in FIG. 3:

Step 1-1: A second node transmits a first configuration message to a first node. The function of the message is to provide the first node with configuration information for data transmission. The message comprises at least one of the following information:
First number information, where the information is used to indicate the number of the current system frame, that is, the number of the system frame where the first node is when receiving the first configuration message. In one embodiment, the first number information is SFN (System frame number), and the length of one frame is 10 ms; in another embodiment, the first number information can be information whose value range is an integer, and can be named by frame status information, and it can also be named by other names; taking “frame status information” as an example, this information has a certain value range, such as 1˜1000, 1˜500, this information will increase with the increase of SFN, and when the “frame status information” increases to be greater than the maximum value, the “frame status information” will become zero, such as the current “frame status information” is 1000 (1000 is the maximum value of the frame status information), when SFN increases by 1 more (that is, when entering the next SFN), the “frame status information” becomes zero; in another embodiment, the first number information can be the number information of a super system frame, such as H-SFN, Hyper-SFN, this information will increase by 1 every time a period of time passes, an example of this period of time can be 1024 system frames, that is, when the SFN becomes 1023 or 0, the H-SFN will increase by 1.
Second number information, which indicates the number information of a reference system frame, which can be used to obtain the start time of the transmission cycle. In an example, this information is used to obtain the start time of the DRX short cycle, for example, the start time of the Nth short cycle satisfies [(SFN×10)+subframe number]=(second number information×10+offset information+N×short cycle) modulo (10240), an example of this offset information is drx-StartOffset
Transmission period information, the function of which is to indicate periodrelated information required by the first node when performing data transmission (or signal monitoring, such as PDCCH monitoring), so as to adapt to the features of user service for data transmission and reduce user energy consumption. The transmission period information comprises at least one of the following information:
First period information, which indicates a first period required for the first node to perform data transmission (or signal monitoring, such as PDCCH monitoring). In one embodiment, the period is a short DRX Cycle in DRX (short DRX period cycle); in another embodiment, the period is a long DRX Cycle in DRX (long DRX period cycle); in yet another embodiment, the period is a period in a search space configuration (monitor period); and in yet another embodiment, the period is a super period, such as Super DRX cycle, super monitor period.
First offset information, which indicates an offset of the first period required for the first node to perform data transmission (or signal monitoring, such as PDCCH monitoring), that is, an offset corresponding to the above “first period information”. In one embodiment, the offset information is a start offset for DRX; in another embodiment, the offset is an offset for a search space configuration; and in yet another embodiment, the offset is an offset for a super period.
Second period information, which indicates a second period required for the first node to perform data transmission. This period is different from the above “first period information”, which may be a period used within the above first period. In one embodiment, the period is a sub-cycle period (such as sub-cycle); in another embodiment, the period is a short DRX Cycle in DRX (short DRX cycle period); in yet another embodiment, the period is a long DRX cycle in DRX; and in yet another embodiment, the period is a period in a search space configuration (monitor period). Furthermore, the second period may be used in cooperation with the above “first period information”. For example, the second period is a second period used in a period indicated by the first period information. For example, the period indicated by the above first period is 50 ms, and the period indicated by the second period is 17 ms, such that, within 50 ms, the first node will have a data transmission performed based on a period of 17 ms. A detailed description of the behaviours of the first node will be introduced in the second aspect.
Second offset information, which indicates an offset of the second period required for the first node to perform data transmission (or signal monitoring, such as PDCCH monitoring), that is, an offset corresponding to the above “second period information”. In one embodiment, the offset information is a start offset for DRX; in another embodiment, the offset is an offset for a search space configuration; and in yet another embodiment, the offset is an offset for a sub-cycle.
First configuration information, the function of which is to indicate configuration information required for the first node to perform reception and transmission of the first signal. The beneficial effect of this information is to indicate that a user receives a signal only within a configured time, thereby reducing the energy consumption by the user. In one embodiment, the “reception and transmission of the first signal” means that the first node monitors a PDCCH. Furthermore, if the first node receives scheduling information for the first node when monitoring the PDCCH, the first node proceeds with reception and transmission of data according to the scheduling information. The first configuration information comprises at least one of the following information:
First signal monitoring configuration information, which indicates configuration information required for monitoring a signal. In one embodiment, the information indicates configuration information required to perform PDCCH monitoring, such as a configuration of a search space, and the configuration indicates configuration information required for the first node to perform signal monitoring, such as a period, an offset, a resource, time length of receiving and transmitting a signal, symbols for receiving and transmitting a signal, a candidate of a search signal, and a type of a search space. For details, please refer to the description of the current SearchSpace IE. Furthermore, the configuration information may indicate a relatively sparse configuration (that is, the configuration indicates that the first node transmits and receives signals less frequently, for example, in the mechanism of search space set group switch, the sparse configuration is a default configuration for a search space, or a first configuration for the search space, or a second configuration for the search space, or a third configuration for the search space, etc.)
First trigger indication information, the function of which is to indicate a time when the first node triggers and/or starts (please note that “trigger” and “start” are used interchangeably in this document) reception and transmission of a signal configured by the above “first signal monitoring configuration information”. In one embodiment, after the first node is configured with DRX, the indication information indicates that when a timer of the first node (such as On duration timer in DRX mechanism) is started, the first node needs to perform reception and transmission of a signal according to the above “first signal monitoring configuration information.” The specific description of the behaviours of the first node will be introduced in the second aspect.
First trigger timer information, which indicates a timer required for the first node starts reception and transmission of a signal configured by the above “first signal monitoring configuration information”. In one embodiment, after the first node is configured with DRX, the first node needs to use the configuration information indicated by the above “first signal monitoring configuration information” to perform reception and transmission of a signal within a time indicated by the “first trigger timer information” before a timer (such as on duration timer in DRX mechanism) is started.
Second configuration information, the function of which is to indicate configuration information required for the first node to perform reception and transmission of a second signal. The beneficial effect of this information is to help the user to know in time whether the user has data to be received and transmitted. In one embodiment, the “reception and transmission of a second signal” means that the first node starts monitoring a physical signal, such as a WUS (Wake-up signal), or a PEI (Paging Early Indication) signal, etc. Furthermore, the function of the signal may inform the first node whether there is data to be received or transmitted, and if the signal informs the first node that there is data of the first node to be transmitted or received on the network side, the first node will start reception or transmission of the data (in one example, if the first node is configured with DRX, the first node will start On duration timer or the first node will enter Active time, and then start transmission or reception of data of the first node). The second configuration information comprises at least one of the following information:
Second signal monitoring configuration information, which indicates configuration information required for monitoring the second signal, such as configuration for the WUS and the configuration for the PEI. The information may comprise at least one of a period, an offset, and a resource.
Second trigger indication information, the function of which is to indicate a time when the first node start reception and transmission of a signal configured by the above “second signal monitoring configuration information”. In an embodiment, after the first node is configured with DRX, the indication information indicates that when a timer of the first node (such as On duration timer in DRX mechanism) is started, the first node needs to perform reception and transmission of a second signal according to the above “second signal monitoring configuration information”. In another embodiment, when configuration information for a search space indicates that the user needs to start PDCCH monitoring, the user may perform monitoring of the second signal according to the above “second signal monitoring configuration information”, and if the second signal informs the user that there is new data to be transmitted, the monitoring of the PDCCH is performed according to the configuration information for the search space. The specific description of the behaviours of the first node will be introduced in the second aspect.
Second trigger timer information, which indicates a timer required for the first node starts reception and transmission of a signal configured by the above “second signal monitoring configuration information”. In one embodiment, after the first node is configured with DRX, the first node needs to use the configuration information indicated by the above “second signal monitoring configuration information” to perform reception and transmission of a signal within a time indicated by the “second trigger timer information” before a first timer (such as On duration timer in DRX mechanism) is started. In another embodiment, after the first node is configured with a search space, the first node needs to use the configuration information indicated by the above “second signal monitoring configuration information” to perform reception and transmission of a signal within a time indicated by the “second trigger timer information” before starting PDCCH monitoring.

The structure and content of the first configuration information and the second configuration information are basically the same. The differences mainly lie in that the first configuration signal is for reception and transmission of the first signal (e.g., PDCCH), and the second configuration signal is for reception and transmission of the second signal (e.g., WUS or PEI).
Third configuration information, which indicates a configuration of the first node related to PDCCH monitoring, so as to dynamically configure the user's monitoring of PDCCH according to service features. The beneficial effect of this information is to help the user obtain the time to perform PDCCH monitoring and reduce unnecessary energy consumption. Furthermore, the “third configuration information” will also comprise multiple sets of “configurations related to PDCCH monitoring”, and for each set of configurations, the third configuration information comprises at least one of the following information:
Offset time to start monitoring (for example, after receiving an indication to start PDCCH monitoring, the first node needs to wait for the offset time before starting PDCCH monitoring),
Time length of monitoring, which indicates a time length for which the first node needs to monitor PDCCH after starting PDCCH monitoring,
First state indication information, which is used to indicate whether a set of configurations is in an active state. If it is in an active state, the first node will monitor the PDCCH according to the configurations, otherwise it will not.

In an embodiment, the configuration information for PDCCH monitoring indicated by the “third configuration information” is different from the configuration of the existing search space. The configuration of the existing search space provides a configuration for performing periodic PDCCH monitoring while the “third configuration information” gives a one-time configuration, that is, once a time for PDCCH monitoring indicated by this information expires, the first node stops PDCCH monitoring.

In another embodiment, the third configuration information comprises second state indication information, which indicates whether one or more sets of configuration information in the multiple sets of configuration information are in an active state(s).
First timer information, which indicates configuration information of a first timer required by the first node to perform reception and transmission of data and/or signal, and the timer indicates a time for the user to perform reception and transmission of data and/or signal or a configured switch time required to perform reception and transmission of data and/or signal. The beneficial effect of the information is to help the user to determine a time length for data reception and transmission, to avoid unnecessary data transmissions, and to reduce energy consumption. In one embodiment, the timer is a timer configured to the first node when configuring DRX, such as On duration timer, Inactivity timer, downlink retransmission timer, uplink retransmission timer, etc. In another embodiment, the first timer is a timer required for configuring the search space set switch of the first node, such as a search space switch timer, and the function of the timer is to indicate that the first node switches from a configuration for a search space to another configuration for the search space. The information may comprise one or more configurations for length information. If multiple configurations for length information are included, the multiple configurations for length information are for different values of a timer. For a configuration of length information, the first timer information comprises at least one of the following information:
First timer length information, which indicates an initial length of a timer when the timer is started or restarted. The length of the timer decrements over the time until it becomes 0 (that is, the timer expires). When the timer gradually decrements, the timer may also be restarted, that is, the timer will be reset to the length indicated by the “first timer length information” (initial length).
First condition information, which indicates condition information for starting or restarting the timer, and furthermore, the information indicates a condition for starting or restarting for a length indicated by the above “first timer length information”. In one embodiment, the condition information indicates a number of new transmissions experienced by the first node when starting or restarting for the length indicated by the above “first timer length information” (for example, if the condition information is set to 5, it means that when the first node receives indication of a fifth new transmission, starting or restarting the timer needs to be performed according to the length indicated by the above “first timer length information” when starting or restarting the timer. In one embodiment, the fifth new transmission refers to the fifth one in a DRX cycle). In another embodiment, the condition information indicates that the first node uses a specific configuration for the search space (a default configuration for the search space, or a first configuration for the search space, or a second configuration for the search space, or a third configuration for the search space, etc.) when starting or restarting the length indicated by the above “first timer length information” (For example, if the condition information is set to 5, it means that when the first node uses the first configuration for the search space for the fifth time, starting or restarting the timer needs to be performed according to the length indicated by the above “first timer length information” when starting or restarting the timer. In one embodiment, the fifth time using the first configuration for the search space is the fifth time within a DRX cycle).
Decrement step size information, which indicates decrement information of the initial length of the timer set when starting or restarting the timer (or a step size of the timer when it is decremented). After the first node receives this information, when the timer is started, the used initial value thereof will be gradually decremented, or the timer will be decremented according to the length indicated by this information (for example, when the decrement step is 2, the timer will be decremented by 2 time slots when it is decremented, for example, the timer length would be 10, 8, 6, . . . ).
First applicability information, which indicates information of an applicable scope(s) of one or more pieces of information included in the above “first timer information”, such as PDU session identifier, QoS flow identifier, DRB (Data Radio Bearer) identifier, logical channel identifier, logical channel group identifier, and these information respectively indicates one or more of the PDU session, QoS flow, DRB, logical channel or logical channel group to which the information included in the above “first timer information” is applicable.
Third state indication information, which is used to indicate whether the above “configuration for length information” is in an active state. If it is in an active state, the first node will use the configuration, otherwise it will not.

In another embodiment, the first timer information comprises fourth state indication information, which indicate whether one or more sets of configurations for length information among multiple sets of configurations for length information are in an active state(s).
Second timer information, which indicates information related to a second timer required for a configuration of the first node to perform reception and transmission of data and/or signal, wherein the second timer indicates a time required to use the configuration to perform reception and transmission of data and/or signal. When the second timer expires, the first node no longer uses the configuration to perform reception and transmission of data and/or signal. The beneficial effect of this information is to indicate that the user performs reception and transmission of data and/or signal according to a specific configuration, so as to avoid unnecessary energy consumption. In one embodiment, the “configuration of the first node to perform reception and transmission of data and/or signal” may be a configuration of the search space used by the first node (such as a default configuration for the search space, or a first configuration for the search space, or a second configuration for the search space, or a third configuration for the search space, etc.), When the second timer expires, the first node no longer uses the configuration of the search space to perform reception and transmission of data and/or signal. In another embodiment, the “configuration of the first node to perform reception and transmission of data and/or signal” may be a configuration of DRX used by the first node or a configuration of a parameter (such as On duration timer, Inactivity timer, downlink retransmission timer, uplink retransmission timer, etc.) in the DRX configuration. After the second timer expires, the first node no longer uses the configuration of DRX or the configuration of the parameter (such as On duration timer, Inactivity timer, downlink retransmission timer, uplink retransmission timer, etc.) in the DRX configuration. In yet another embodiment, the “configuration to perform reception and transmission of data and/or signal” may be a configuration of a monitoring signal used by the first node (such as monitoring WUS signal, or PEI signal, or other signals). After the second timer expires, the first node no longer monitors the signal. The “second timer information” comprises at least one of the following information:
Second timer length information, which indicates an initial length of a timer when the timer is started or restarted. The length of the timer decrements over the time until it becomes 0 (that is, the timer expires). When the timer gradually decrements, the timer may also be restarted, that is, the timer will be reset to the length indicated by the “second timer length information” (initial length).
Second applicability information, which indicates information of an applicable scope(s) of one or more pieces of information included in the above “second timer information”, such as PDU session identifier, QoS flow identifier, DRB identifier, logical channel identifier, logical channel group identifier, and these information respectively indicates the PDU session, QoS flow, DRB, logical channel or logical channel group to which the information included in the above “second timer information” is applicable.
State indication information, which is used to indicate whether the above “second timer information” is in an active state. If it is in an active state, the first node will use this configuration, otherwise it will not.
   DRX configuration information, which provides a configuration required for the first node to perform DRX. Unlike the related art, the configuration information may comprise one or more sets of DRX configuration information, and each set of configuration information corresponds to a different service. The beneficial effect of this information is to help the user configure DRX for different services, and then to perform reception and transmission of data according to features of the services, so as to avoid unnecessary energy consumption. For the set of configuration information, the information comprises at least one of the following information:
   First configured DRX information, which comprises a configuration of parameters for performing DRX, such as DRX cycle, offset, On duration timer, inactivity timer, RTT timer, retransmission timer, etc. For details, please refer to the current DRX-Config.
   Applicable scope information, which indicates an applicable scope of the above “first configured DRX information”, such as PDU session identifier, QoS flow identifier, DRB identifier, logical channel identifier, logical channel group identifier, and these information respectively indicates the PDU session, QoS flow, DRB, logical channel or logical channel group to which the information included in the above “first configured DRX information” is applicable.
   Fifth state indication information, which is used to indicate whether a set of configurations is in an active state. If it is in an active state, the first node will perform DRX according to the configurations, otherwise it will not.
Indication information of a default configuration (or main configuration, wherein the default configuration may also be replaced by the main configuration), the function of which is to indicate whether the above “first configured DRX information” is the default configuration, and if it is the default configuration, the user will perform DRX according to this configuration by default.

In another embodiment, the DRX configuration information may comprise sixth state indication information, which indicates whether one or more sets of DRX-related configuration information among multiple sets of DRX-related configuration information are in an active state(s).

After the first node receives the above multiple sets of configuration information, the first node needs to determine which configuration information needs to be used, and the behaviours on the side of the first node will be described in the second aspect of the present invention.

Step 1-2: Optionally, the first node transmits a first configuration response message to the second node. The function of the message is to confirm reception of the first configuration message and inform the first node that the configuration in the first configuration message has been completed.

Step 1-3: Optionally, the second node transmits a second configuration message to the first node. The function of the message is to indicate configurations required for data transmission. In one embodiment, these configurations are one of the configurations provided in Step 1-1. The message comprises at least one of the following information:
First start indication information, which indicates whether the first node starts a configuration for a search space (such as a default configuration for the search space, or a first configuration for the search space, or a second configuration for the search space, or a third configuration for the search space, etc.) to perform detection of PDCCH. The beneficial effect of this information is to help the user start a suitable configuration to perform detection of PDCCH and reduce the energy consumption by the user. In one embodiment, the indication information may be transmitted to the first node when the On duration timer is started, and if the indication information indicates that the first node starts using a default configuration for the search space (first configuration for the search space, that is, time to detect PDCCH is relatively sparse) to detect PDCCH, the first node will start to detect PDCCH in the sparse time every time the on duration timer for DRX is started, which decrease the times of detection of PDCCH by the first node, thereby saving the energy of the first node.
First stop indication information, the information indicates whether the first node may stop reception of the first signal (for example, monitoring of PDCCH). The beneficial effect of the information is to help the user stop reception of signals in time and save energy. In one embodiment, if the first node is configured with DRX and the first node is in Active time, when the first node receives the “first stop indication information”, the first node will stop reception of signals (for example, monitoring of PDCCH), terminate the active time early, and then enter inactive time. In another embodiment, the indication information may indicate that the user skips monitoring of PDCCH, that is, if the first node is configured with DRX, and the first node is in the Active time, the first node will skip monitoring of PDCCH in the remaining Active time after receiving the indication information.
First time indication information, which indicates an initial length to be used when the first node starts a timer. The beneficial effect of this information is to configure the time required for the user to perform reception of data and/or signal, thereby saving the user's energy. In one embodiment, when information of multiple lengths of a timer is configured for the first node in Step 1-1 (for example, multiple lengths of a timer configured in the above “first timer information”, or multiple lengths of a timer configured in the above “second timer information”), the “first time indication information” may be used to indicate which one of the “information of multiple lengths” is used by the first node to set the initial value of the timer when it is started or restarted. For example, the first node is configured with multiple values of DRX Inactivity timer in Step 1-1, and the “first time indication information” may indicate which value the first node should use to set the initial value of the Inactivity timer when it is started or restarted; for another example, the first node is configured with multiple values of the Search space switch timer in Step 1-1, and the “first time indication information” may indicate which value the first node should use to set the initial value of the Search space switch timer when it is started or restarted.
   Second time indication information, which in one embodiment indicates initial lengths of multiple timers triggered and/or started by the first node. In another embodiment, the indication information is used to indicate multiple initial lengths used when the first node starts multiple identical timers. For example, in Step 1-1, the first node is configured with a plurality pieces of length information of the Inactivity timer (or on duration timer, or downlink retransmission timer, or uplink retransmission timer, or start offset, or Search space switch timer, etc.), and the second time indication information may be used to indicate initial values of each Inactivity timer that is started. In yet another embodiment, the indication information is used to indicate whether the first node starts multiple different timers and related parameters. For example, the indication information indicates two or more of the Inactivity timer, on duration timer, downlink retransmission timer, uplink retransmission timer, start offset, and Search space switch timer. In yet another embodiment, the indication information is used to indicate whether the first node starts multiple different timers and related parameters (for example, the indication information indicates whether two or more timers in the Inactivity timer, on duration timer, downlink retransmission timer, uplink retransmission timer, start offset and Search space switch timer are started) and one of multiple initial values of each of the timers. In addition, the “second time indication information” may be implemented in the form of a bitmap. If this bitmap is used to indicate different initial values for starting multiple identical timers, each bit is used to indicate an initial value to start with, a bit of “1” representing starting a timer with an initial value corresponding to the bit. If this bitmap is used to indicate different timers, each bit is used to indicate a timer to be started, for example, a bit of “1” indicates that the timer corresponding to this bit needs to be started. If this bitmap is used to indicate different initial values of different timers, each bit may be used to indicate a timer to be started and an initial value of the timer, for example, a bit of “1” indicates that the timer corresponding to this bit has been started with the initial value of the timer. The beneficial effect of this information is to help the user to determine configurations suitable for the service currently serving the user, and to reduce the energy consumption by the user.
   First configuration indication information, which indicates a configuration needed to be adopted by the first node. For example, when multiple DRX configurations are configured for the first node through Step 1-1, the indication information may indicate a DRX configuration needed to be used by the user. The beneficial effect of this information is to help the user determine the configuration for performing reception and transmission of data, and reduce the energy consumption by the user. For example, in Step 1-1, the first node is configured with multiple DRX configurations (each configuration comprises a configuration for at least one parameter of Inactivity timer, on duration timer, downlink retransmission timer, uplink retransmission timer, and start offset), and the “first configuration indication information” may be used to inform the first node of one or more DRX configuration needed to be adopted
   Second configuration indication information, which is used to indicate a configuration for the user to perform PDCCH monitoring, and the indicated configuration may be one or more configurations in the “third configuration information” configured in Step 1-1. The beneficial effect of this information is to help the user determine a configuration for performing reception and transmission of data, and reduce the user's energy consumption.

Furthermore, in order to help the network side to perform the configuration, optionally, Step 1-0 is also included, wherein the first node transmits a first assistant message to the second node, and the message comprises at least one of the following information:
Information related to service features, which comprises at least one of the following information:
Period information
Jitter information, such ase mean value of the jitter, variance of the jitter, mean square error of the jitter, etc.
Burst size information, such as average value of the data size of a burst, maximum value of the data size, minimum value of the data size, variance of the data size, mean square error of the data size, etc.

The beneficial effect of the information is to help the second node to obtain the service features of the user, thereby generating configuration information suitable for performing reception and transmission of data of the user service, and reducing the energy consumption by the user.
Desired configuration information, which indicates a configuration expected by the user. The user may be provided with one or more sets of configurations. For a set of configurations, the information comprises at least one of the following information:
UDRX configuration information, which comprises a configuration of DRX parameters, such as DRX cycle, offset, On duration timer, inactivity timer, RTT timer, retransmission timer, etc. For details, please refer to the current DRX-Config
Configuration information of search space, which comprises a configuration of PDCCH search space, such as period, offset, time length, DCI type, aggregation level, etc. For details, please refer to configuration of current search space
Signal configuration information. The information may be for signals such as WUS signal or PEI signal. For details, please refer to the current WUS signal configuration or PEI signal configuration (such as period, offset, etc.).

The beneficial effect of the information is to help the second node to generate configuration information suitable for performing reception and transmission of data of user service, thereby reducing energy consumption by the user.

After receiving the message, the second node determines the configuration information in Step 1-1 and/or Step 1-3 according to the content in the message.

In the above process, Steps 1-1 and 1-2 may be configured through a RRC message (such as RRCReconfiguration), while Step 1-3 may be configured through a RRC message (such as RRCReconfiguration) or MAC layer signalling (such as MAC Control Element) or physical layer signalling (such as Downlink control information) configuration, and may also be configured through other types of messages or signalling. Step 1-0 may be transmitted through a RRC message, such as UEAssistantInformation, or through other types of messages or signalling.

### Second Aspect: Operations of User Equipment

After the user obtains the configuration information through the signalling interaction of the first aspect of the present invention, the user needs to perform reception and transmission of a signal according to the configuration information. According to different configurations, user behaviours will be different, and different configurations are aimed at different problems. Accordingly, the second aspect of the present invention mainly introduces user-side behaviours. For the convenience of description, the user's behaviours will be described below from the perspective of different technical issues.

### Technical Problem 1: Adapt to the Period Configuration of XR Service

The generation of the existing XR services is periodic, and for an ideal network, arrival of the XR service at the base station also exhibits periodicity when it reaches the base station. However, due to the uncertainty of actual network transmission, time jitter may occur when the XR service arrives at the base station, that is, the arrival of the XR service monitored on the base station side may not be periodic. Even so, if the base station may follow the feature of periodicity of the XR service as best as possible when configuring a DRX period or search space, data transmission of the XR service may be well matched, that is, the user only needs to receive data when the XR service arrives, so as to achieve the effect of energy saving for the user. In order to configure a period that matches features of the XR service, a technical problem is that the period of the XR service is non-integer. For example, if the period of an XR service is 60 fps (frame per second), 90 fps, and 120 fps, a period of an XR frame is 16.666 ms, 11.1111 ms, 8.3333 ms, respectively. It is difficult to transmit such a non-integer period to the user through a suitable configuration, and it is difficult for the user to implement such a non-integer period. In order to solve this problem, the present invention proposes a two-level method for configuring a period: In this method, the user will be configured with two different periods, one is a large period and the other is a small period. Taking PDCCH monitoring by the user as an example, the large period indicates the pattern repetition period of PDCCH monitoring by the user, the small period indicates a period in which the user performs PDCCH monitoring within the large period. And when the user performs PDCCH monitoring in a small period within a large period, a PDCCH monitoring mode may be formed, and this mode will be repeated continuously according to the large period. Specifically, the configuration of the large period comprises cycle-1 and start offset-1, and the configuration of the small period comprises cycle-2 and start offset-2. If the value of start offset-1 or start offset-2 is 0, the configuration Start offset-1/start offset-2 may not be included. The start time of a large period can be determined according to the first number information and/or the second number information, subframe number, cycle-1 and start offset-1, and within a large period, the start position of a small period can be determined according to the first number information and/or second number information, subframe number, cycle-1, start offset-1, cycle-2, start offset-2:
In one embodiment, the first number information is SFN. The subframe position that satisfies [(SFN×10)+subframe number] modulo (Cycle-1)=(Start Offset-1) of modulo (Cycle-1) is the position where the large period starts, the subframe position that satisfies {[(SFN×10)+subframe number] modulo (Cycle-1)} modulo (Cycle-2)=(Start Offset-2) modulo (Cycle-2) is the position where the small period starts.
In an embodiment, the first number information can be information whose value range is an integer, and can be named by frame status information, or can be named by other names. For the introduction of this information, please refer to the “First Number Information” in the “First Configuration Message”. The subframe position that satisfies [(“frame state information”×10)+subframe number] modulo (Cycle-1)=(Start Offset-1) modulo (Cycle-1) is the position where the large period starts, the subframe position that satisfies {[(“Frame state information”×10)+subframe number] modulo (Cycle-1)} modulo (Cycle-2)=(Start Offset-2) modulo (Cycle-2) is the position where the small period starts.
In another embodiment, the first number information may be the number information of a hyper system frame, such as H-SFN, Hyper-SFN, the introduction of this information can refer to the “First Number Information” in the “First Configuration Message”. The subframe position that satisfies [(SFN+1024*first number information)×10+subframe number] modulo (Cycle-1)=(Start Offset-1) modulo (Cycle-1) is the position where the large period starts, and the subframe position that satisfies {[(SFN+1024*first number information)×10+subframe number] modulo (Cycle-1)} modulo (Cycle-2)=(Start Offset-2) modulo (Cycle-2) is the position where the small period starts.
In another embodiment, it can be determined by using the first number information and the second number information. For example, the first number and the subframe number of the starting position of the Nth large period satisfy the following formula, [(first number information×10)+subframe number]=(second number information×10+Start offset-2+N×Cycle-1) modulo (10240), and the subframe position that satisfies {[(first number information+1024*second number information)×10+subframe number] modulo (Cycle-1)} modulo (Cycle-2)=(Start Offset-2) modulo (Cycle-2) is the position where the small period starts.

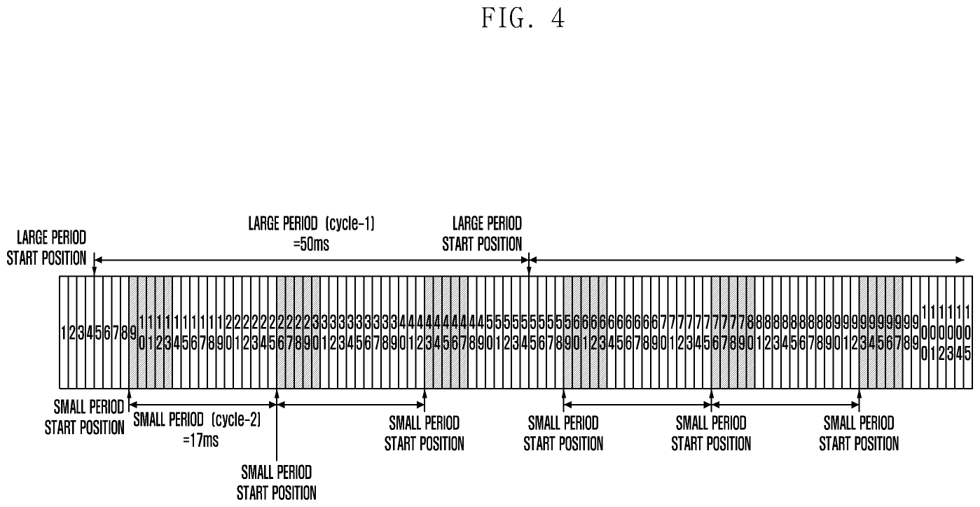

After the user determines the starting position of each small period, one can determine the monitoring of PDCCH according to other configurations, such as determining the start time of drx-OnDurationTimer according to drx-SlotOffset, that is, after determining the starting position of the small period, drx-OnDudratiomTimer starts after drx-SlotOffset from the start of the subframe. The start time of the large period may be determined according to SFN, subframe number, cycle-1 and start offset-1, such as when a subframe position that satisfies [(SFN×10)+subframe number] modulo (Cycle-1)=(Start Offset-1) modulo (Cycle-1) is the position where the large period starts, and in a large period, the starting position of a small period may be based on SFN, subframe number, cycle-1, start offset-1, cycle-2, start offset-2 to determine, such as when a subframe position that satisfies {[(SFN×10)+subframe number] modulo (Cycle-1)} modulo (Cycle-2)=(Start Offset-2) modulo (Cycle-2) is the starting position of the small period, after the user determines the starting position of each small period, the user may determine the monitoring of the PDCCH according to other configurations. In one embodiment, if the user's DRX is configured, cycle-1 and start offset-1 may be DRX short/long cycle and start offset in the related art, respectively, while cycle-2 and start offset-2 are newly configured information; while after determining the starting position of each small period, the user may perform the PDCCH monitoring according to other configurations (such as inactivity timer, retransmission timer, RTT timer, etc.); in another embodiment, if the user's search space is configured, cycle-1 and start offset-1 are the existing configuration (such as the current MonitoringSlotPeriodAndOffset), while cycle-2 and start offset-2 are newly configured information; after the user determines the start position of each small period, the user may perform the PDCCH monitoring according to other configured configurations (such as duration, searchspaceType, etc. in current searchspace). FIG. 4 shows an example, where cycle-1=50 ms, start offset-1=5 ms, cycle-2=17 ms, start offset=9 ms, in such a case, the starting positions of the large periods are subframes 5 and 55 respectively, and the starting positions of the small periods are subframes 9, 26, 43, 59, 76, and 93, respectively, and the subframes for which the user monitors the PDCCH are one or more subframes starting from the start position of each small period (the figure shows 5 subframes), but the actual number of subframes is determined according to the other configurations described above, and descriptions thereof is not be repeated here). When implementing the configuration of the large and small period, there are two implementations:

### Method 1: Newly Defining a Small Period and Reusing Existing Configuration for a Large Period

In this method, the configuration for the first node by the second node comprises the transmission period information in the above Step 1-1, wherein the first period information and the first offset information correspond to the above configuration of the large period (including cycle-1 and start offset-1, for DRX, it may be configured by using the existing DRX short/long Cycle and start offset respectively. For the configuration of the search space, it may be configured by using the existing MonitoringSlotPeriodAndOffset), and the second period information and the second offset information corresponds to the configuration of the above small period (including cycle2 and start offset-2, which is the new configuration information).

Method 2: Newly defining the large period, and reusing the existing configuration for the small period

In this method, the configuration for the first node by the second node comprises the transmission period information in the above Step 1-1, wherein the first period information and the first offset information correspond to the above configuration of the large period (including cycle-1 and start offset-1, which is a new configuration), and the second period information and the second offset information correspond to the above configuration for the small period (including cycle-2 and start offset-2, which is configured using the existing DRX short/long Cycle and start offset).

The beneficial effect of the above method is that the period of PDCCH monitoring configured for the user may better match the period of the XR service, so as to ensure that the user may start the monitoring of the PDCCH once the XR service arrives to the utmost extent.

### Technical Problem 2: Jitter of Arrival of XR Packet

Although the generation of a XR service is periodic, jitter will occur when the XR data packets transmitted through the actual network arrive at the base station, that is, they do not arrive in full periodicity. If the base station configures PDCCH monitoring by the user fully based on the periodicity of the XR service, it is possible that sometimes the user has not started monitoring the PDCCH when the XR data packet arrives, which will increase the XR latency, and the following case is also possible to occur: there is no XR data packet when the user starts monitoring the PDCCH, and thus leading to unnecessary energy consumption by the user. In order to ensure fulfilling the time latency requirement and take into account energy consumption by the user, a technical problem is how to configure the reception of user signals (such as PDCCH monitoring) in consideration of the jitter of the arrival of data packets. In order to solve this technical problem, the present invention proposes the following methods:

Method 1: User Starts Monitoring with a Sparse PDCCH Monitoring Configuration at the Beginning of Active Time

After the user is configured with DRX, when the on duration timer is started, the user monitors the PDCCH with a specific PDCCH monitoring configuration (such as a configuration indicated by configuration information for the search space, which for example is a default configuration for the search space, or a first configuration for the search space, or a second configuration for the search space, or a third configuration for the search space, etc.). In one embodiment, the specific configuration indicates a relatively sparse PDCCH monitoring. For example, in multiple subframes, the number of subframes for which the user performs PDCCH monitoring is small. In order to implement this method, the base station needs to transmit configuration information to the user, such as the “first trigger indication information” in the “first configuration information” in the above Step 1-1, and the “specific PDCCH monitoring configuration” may be given through the “first signal monitoring configuration information” in the “first configuration information” in the above Step 1-1.

Method 2: User Starts Monitoring with a Sparse PDCCH Monitoring Configuration Before the Active Time Starts.

After the user is configured with DRX, within a period of time before the On duration timer is started (this period of time being configured by the base station), the user performs monitoring of the PDCCH with a specific PDCCH monitoring configuration (such as a configuration indicated by configuration information for the search space, which for example is a default configuration for the search space, or a first configuration for the search space, or a second configuration for the search space, or a third configuration for the search space, etc.). In one embodiment, the specific configuration indicates a relatively sparse way for PDCCH monitoring. For example, in multiple subframes, the number of subframes for which the user performs PDCCH monitoring is small. In order to implement this method, the base station needs to transmit configuration information to the user, such as the “first trigger timer information” in the “first configuration information” in the above Step 1-1, and the “specific PDCCH monitoring configuration” may be given through the “first signal monitoring configuration information” in the “first configuration information” in the above Step 1-1.

Method 3: User Monitors a Physical Signal that Informs Whether there is Data to Arrive

The base station informs the user whether there is new data to be transmitted through a signal, and the user monitors the signal. If the received signal informs the user that there is new data to be transmitted, the user starts monitoring the PDCCH. The signal may be a WUS signal, a PEI signal, or another new signal. In order for the user to receive the signal, the base station needs to transmit configuration information of the signal to the user, such as the “second signal monitoring configuration information” in the “second configuration information” in the above Step 1-1. In one embodiment, the user may first start monitoring the signal when the On duration of DRX starts, and if the signal informs that there is new data to be transmitted, the user starts monitoring the PDCCH. In another embodiment, when the user starts the PDCCH monitoring according to a configuration for the search space, the user may start with monitoring this signal, and if the signal informs that there is new data to be transmitted, the user starts the monitoring of the PDCCH. In order to indicate that user to start monitoring the signal at the above specific time, the base station needs to transmit configuration information to the user, such as the “second trigger indication information” in the “second configuration information” in the above Step 1-1. In yet another embodiment, the user may monitor the signal within a period of time before the start of a specific moment (such as upon start of on duration of DRX, the start moment of PDCCH monitoring indicated by the configuration information for the search space). The “period of time” is configured by the base station to the user, such as the “second trigger timer information” in the “second configuration information” in the above Step 1-1.

The beneficial effect of the above methods is that before user data arrives, the user may relatively infrequently perform reception of signals (such as PDCCH monitoring, physical signal reception, etc.), thereby reducing the energy consumption by the user.

### Technical Problem 3: Termination of XR Packet Burst

XR data packets also arrive in bursts, and a burst may contain one or more data packets. If the base station may know that the data packet it is transmitting is the last data packet in a burst, the base station may notify the user to terminate the monitoring of the PDCCH in advance, thereby enabling the energy saving for the user. In an actual system, the number of data packets included in each burst varies, so the base station cannot know which data packet is the last data packet in a burst. If the base station indicates that the user terminates the monitoring of the PDCCH in advance when all data packets in a burst have not been transmitted, it may lead to delayed reception of the subsequent data of the burst, which increases the latency of the XR service; and if the base station does not terminate the PDCCH monitoring by the user after all data packets in a burst are transmitted, it leads to excessive energy consumption by the user. Therefore, in order to achieve a compromise between energy consumption and latency, a technical problem is how to ensure that the user may terminate the monitoring of the PDCCH in time when all data packets in the burst are transmitted. In order to solve this technical problem, the present invention proposes the following methods:

### Method 1: Base Station Transmits Indication Information to Stop Monitoring of PDCCH.

In this method, assuming that the base station may accurately know which data packet is the last data packet in a burst, the base station may transmit the indication information to the user after the transmission of the last data packet is completed. In one embodiment, the indication information may inform the user to stop monitoring of PDCCH. For example, after DRX is configured, if the active time has not been terminated for the user, the base station may transmit the indication information to the user to stop the monitoring of PDCCH by the user. The indication information may be indicated by the “first stop indication information” in the above steps 1-3.

### Method 2: Base Station Dynamically Adjusts Configuration of Timer.

In this method, the base station may dynamically adjust configurations of some timers (e.g., DRX Inactivity timer, Search space switch timer), that is, by indicating initial values of the timers needed to be used by the user. The base station may dynamically determine the values of the timers needed to be used according to the number of data packets of the burst to be transmitted. In order to implement this method, the base station may configure values of multiple timers through the “first timer information” or “second timer information” in the above Step 1-1, and then the base station indicates the values of the timers to be used by the user through “first time indication information” in the above Step 1-3, or directly indicate the values of the timers needed to be used by the user through the “first time indication information” in the above steps 1-3.

### Method 3: Starting Timer Based on Configured Condition Information

In this method, the base station may configure a timer with multiple possible values, and conditions used for each value are also configured to the user. When determining a value of a timer, the user needs to determine conditions that may be currently satisfied. In one embodiment, when the timer is the Inactivity timer in the DRX configuration, the condition information may be first number indication information for new transmissions. That is, the information indicates a length of a timer needed to be used by the user when a number of new transmissions obtained by the user is the number indicated by the first number indication information for new transmissions. For example, the timer length information comprises (100 ms, 1 time), (60 ms, 2 times), (30 ms, 3 times), (20 ms, 4 times), (10 ms, 5 times), . . . , which means that when the user obtains a first new transmission, the Inactivity timer used is 100 ms, and when the user obtains a second new transmission, the inactivity timer it uses is 60 ms, and so on. In order to implement this method, the base station may determine the conditions required to start a certain timer length through the “timer length information” and “first condition information” in the “first timer information” in the above Step 1-1.

### Method 4: Timer is Dynamically Decremented.

In this method, an initial value of a timer is dynamically decreased, so that as the number of transmitted data increases, the length of the timer used by the user becomes shorter. In one embodiment, the information indicates that when the timer is started or restarted, the initial value of the timer needs to be decremented by a step size. For example, the “decrement step size information” is 5 ms, and the length information of the timer is 100 ms. When the timer is started or restarted for a first time, the value of the timer is set to 100 ms. When the timer is started or restarted for a second time, the value of the timer is set to 95 ms. When the timer is started or restarted for a third time, the value of this timer is 90 ms, and so on. In another embodiment, this information indicates that after the timer starts to be decremented in length, when the timer is started or restarted, the initial value of the timer needs to be decremented according to the step size. In this embodiment, it may also include information indicating conditions for starting decrement of the initial length of the timer (the condition information may be configured by the base station to the user), such as information of times to start or restart the timer (that is, when the number of times the timer is started or restarted exceeds the number of times indicated by the information of times, the initial length of the timer will be decremented). For example, the “information indicating conditions for starting decrement” is set to timer being started or restarted three times, and the “decrement step size information” is 5 ms, and the timer length information is 100 ms, then when the number of times the timer is started or restarted is less than or equal to 3, the initial value when the timer is started or restarted is 100 ms; when the timer is started or restarted for a fourth time, the timer starts to be decremented, that is, the initial value when the timer is started or restarted is 95 ms; and when the timer is started or restarted for the fifth time, the initial value when the timer is started or restarted is 90 ms, and so on. In order to implement this method, the base station may indicate the decrement step size of the initial value of the timer through the “decrement step size information” in the “first timer information” in the above Step 1-1.

### Method 5: Configuration of Time to Use a Monitoring Configuration

In this method, the base station may indicate that the user uses a specific monitoring configuration after determining that all data in a burst may be transmitted, and start a timer, which indicates a time to use the specific monitoring configuration, and if the timer expires, the user no longer performs monitoring. In one embodiment, the “specific monitoring configuration” is a configuration for a search space, and if the time for which the user uses this configuration to monitor the PDCCH exceeds a predetermined value (that is, after the timer expires), the user stops the PDCCH monitoring. Furthermore, the base station indicates user to use the “specific monitoring configuration”, or the user switches from using some other specific monitoring configuration (such as a dense PDCCH monitoring configuration) to using the “specific monitoring configuration” (a sparse PDCCH monitoring configuration). In another embodiment, the “specific monitoring configuration” is an initial value of a specific inactivity timer, and if the time for which the user uses the initial value of the specific inactivity timer exceeds a predetermined value (that is, after the timer expires), the user stops the PDCCH monitoring. In yet another embodiment, the “specific monitoring configuration” is a configuration to configure the user to perform monitoring of signals (such as WUS, PEI, etc.). In order to implement this mechanism, the base station may configure the user through the “second timer information” in the above Step 1-1.

The beneficial effect of the above methods is that the user may dynamically adjust the monitoring of signals (such as PDCCH, WUS, PEI, etc.) according to the configuration of the base station, so as to avoid the user entering a sleep state when transmission of all data packets in a burst is not completed, and also it is ensured that after all data in the burst is transmitted, the user does not need to consume high energy to continue monitoring the signal, thereby saving the user's energy and also meeting the latency requirement of XR service transmission.

### Technical Problem 4: Simultaneous Transmission of Multiple XR Service Flows

In order to support an XR service, a user may need to receive or transmit data packets of multiple different service flows, and data packets of these service flows have different features, such as period, packet size, transmission jitter, and so on. As a result, arrival of the data at the base station side is completely irregular. In order to avoid the latency of data transmissions, the user may need to monitor the PDCCH all the time in order to receive or transmit data packets in time, but this will lead to excessive energy consumption by the user, because the user may not have data to be transmitted and received at all time. Therefore, a technical problem is how to reduce the energy consumption by the user while ensuring meeting the latency requirement when multiple XR data flows with different features are transmitted. In order to solve this problem, the present invention proposes the following methods:

### Method 1: Dynamically Indicating DRX Configuration Needed to be Used by User

In this method, the base station provides the user with configuration information for multiple DRX, and the configuration information for multiple DRX may contain at least one of a DRX cycle, offset, On duration timer, inactivity timer, RTT timer, and retransmission timer. For details, please refer to the current DRX-Config. However, the base station will notify the user which configuration to be used at any time through indication information. In one embodiment, the indication information may indicate configuration information for multiple DRX needed to be used by the user, and the indication information indicates a configuration of all or part of parameters for the DRX needed to be used by the user. In order to implement this method, the base station may configure multiple sets of DRX configurations for the user through the “DRX configuration information” in Step 1-1, and indicate the used DRX configuration through the “first configuration indication” in Step 1-3. In another embodiment, the indication information may indicate a configuration of a certain parameter (such as On duration, Cycle, offset, inactivity timer, RTT timer) in the DRX configuration information needed to be used by the user. In order to implement this method, the base station may configure multiple values of a timer for the user through the “first timer information” in Step 1-1, and then indicate an initial value of the timer needed to be used by the user through Step 1-3. In yet another embodiment, the indication information may indicate initial values of multiple timers needed to be used by the user. The multiple timers may be of the same type, for example, all being inactivity timer, or may be different types of timers, such as inactivity timers, on duration timers. In order to implement this method, the base station may configure multiple values of a timer for the user through the “first timer information” in Step 1-1, and then indicate multiple values of a timer needed to be used through the “second time indication information” in steps 1-3.

### Method 2: User Dynamically Adjusts DRX Configuration.

In this method, the base station provides the user with configuration information for multiple DRX, and configuration information for each DRX may comprise at least one of a DRX cycle, offset, On duration timer, inactivity timer, RTT timer, and retransmission timer. For details, please refer to the current DRX-Config. The configuration of the DRX needed to be used by the user is determined by the user according to information the user grasps. In this method, during the performance of DRX by the user, following behaviours that are different from the those of related art will be exhibited:
Behaviour 1: A main DRX configuration (default DRX configuration) is determined. The main DRX configuration is a configuration of DRX used to trigger the user to enter Active time. Specifically, when the user is in an inactive time period (in the inactive state of DRX, that is, when the user does not need to monitor the PDCCH), if the user determines that the on duration timer needs to be started according to information of a DRX configuration obtained by the user, the DRX configuration is the main DRX configuration. When the user cannot determine which DRX configuration parameter should be used during the Active time, the user uses a parameter of the main DRX configuration to start the corresponding timer. The main DRX configuration is the configuration used by the user during the active time. After the user re-enters the inactive time, the user needs to re-determine a main DRX configuration. Accordingly, main DRX configurations of the user may be dynamically changed.
Behaviour 2: User updates a running timer. As described for Behaviour 1, if the user wants to start a timer, but does not know which parameter in the DRX configuration is used to set the initial value, the user may use a parameter in the main DRX configuration to set the initial value. Subsequently, if the user may determine the parameter that should be used (for example, when the user determines the parameter of the DRX configuration that should be used according to the service to which the received data packet belongs, for example, determines the parameter according to the identification information of the logical channel, or the identification information of the logical channel group, or the identification information of the QoS flow, the identification information of the PDU session, the identification information of the DRB contained in the data packet), the user may use the determined parameter of the DRX configuration to update the running timer (if there are multiple DRX configurations determined by the user, the user may update the running timer with the maximum value or the minimum value of the parameters in the multiple configurations). The updated timer may be at least one of On duration timer, inactivity timer, RTT timer, and retransmission timer. Compared with the related art, this behaviour defines a new method for updating a timer, that is, after the user determines the DRX configuration needed to be used (for example, determines the corresponding DRX configuration according to the transmitted data), the user may use the parameter in the determined DRX configuration to update the initial value of the running timer (if the user determines multiple applicable DRX configurations, the user updates the initial value of the running timer with the maximum or minimum value of the parameter in the multiple configurations). Furthermore, the initial value of the timer may be updated when the parameter value in the determined DRX configuration is greater than or less than the remaining time of the running timer.
Behaviour 3: User restarts the running timer. The restarted timer may be at least one of On duration timer, inactivity timer, RTT timer, and retransmission timer. For example, after the on duration timer is started with the main DRX configuration, if during its running, the on duration timer of another DRX configuration (DRX configuration 2) may be started and its initial value is greater or less than the remaining value of the currently running on duration timer, the user may restart the on duration timer and use the value of the on duration timer in DRX configuration 2 as the initial value. In an example, after the inactivity timer is started with the main DRX configuration, if during its running, the user determines the DRX configuration (such as DRX configuration 2) corresponding to the currently newly transmitted data packet, and the initial value of the inactivity timer of DRX configuration 2 is greater than or smaller than the initial value of the currently running inactivity timer, the user may restart the inactivity timer, and use the value of inactivity timer in the DRX configuration 2 as the initial value. Compared with the related art, this behaviour defines a new condition for restarting the timer, that is, after the user determines the DRX configuration corresponding to the transmitted data packet (for example, the user determines the parameter of the DRX configuration that should be used according to the service to which the received data packet belongs, for example, determines the parameter according to the identification information of the logical channel, or the identification information of the logical channel group, or the identification information of the QoS flow, the identification information of the PDU session, the identification information of the DRB contained in the data packet, the user may use the parameter in the determined DRX configuration to restart the timer (if the user determines multiple applicable DRX configurations, the user uses the maximum value of the parameter in the multiple configurations to restart the timer). Furthermore, the user may restart the timer with a new configuration when the parameter in the determined DRX configuration is greater than or less than the remaining time of the currently running timer.

The above three behaviours are illustrated below with three examples:

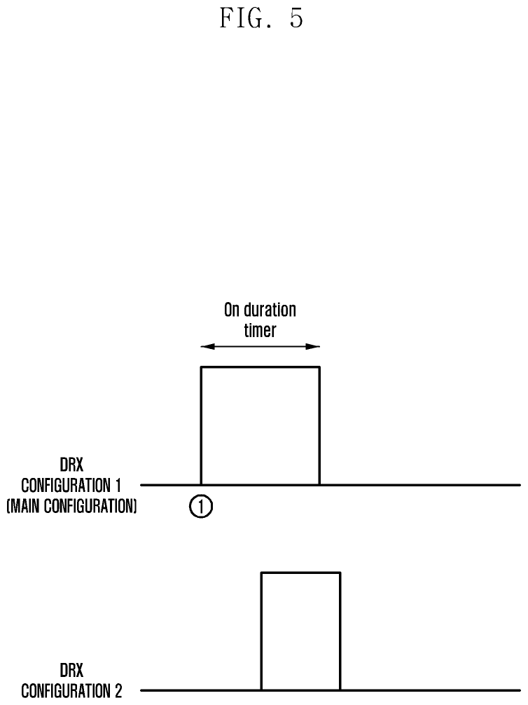

FIG. 5: Selection of a DRX main configuration (default DRX configuration). In the figure, the user is configured with information of two DRX configurations, namely DRX configuration 1 and DRX configuration 2. At time point 1, the user determines that the On duration timer needs to be started according to the parameter in DRX configuration 1, then the user uses DRX configuration 1 as the main configuration.

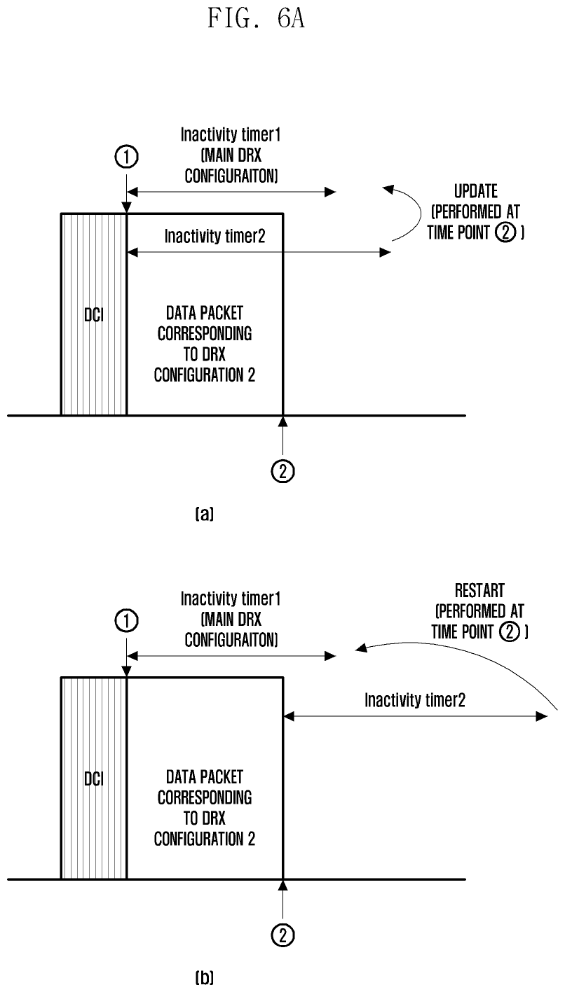

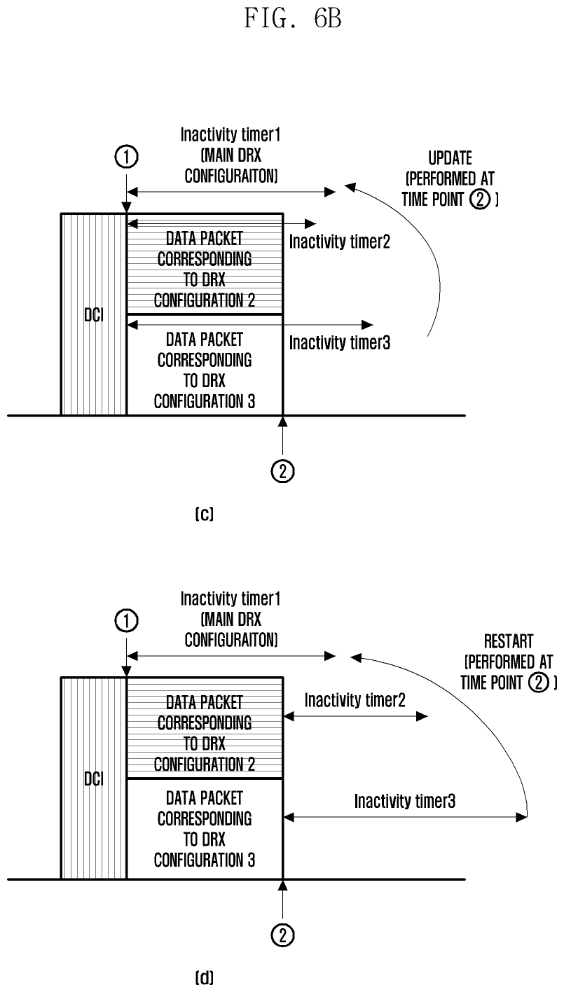

FIG. 6A and FIG. 6B: Update of a timer. At time point 1, the user receives a scheduling information (DCI) for scheduling a new transmission, and the user cannot determine the DRX configuration corresponding to the new transmission. Therefore, the user starts the inactivity timer with the parameter (inactivity timer1) in the main DRX configuration. Subsequently, at time point 2, the user receives the newly transmitted data packet, and the user may determine the configuration of the DRX according to information in the data packet (such as the identification information of the logical channel, or the identification information of the logical channel group, or the identification information of the QoS flow, the identification information of the PDU session, the identification information of the DRB), then in one embodiment, as illustrated in (a) of FIG. 6A, the user uses the inactivity timer (inactivity timer 2) in the determined configuration of the DRX to update the running inactivity timer, that is, taking inactivity timer 2 as the initial value of the timer, and then subtracting the time for which the timer has been running (that is, the time difference between time point 1 and time point 2). In another embodiment, as illustrated in (b) of FIG. 6A, the user restarts the inactivity timer directly with inactivity timer2. In yet another embodiment, as illustrated in (c) of FIG. 6B, if the data packet included in the new transmission corresponds to multiple DRX configurations, the user may use the maximum or minimum value of the inactivity timer in these configurations to update the timer. In yet another embodiment, as illustrated in (d) of FIG. 6B, if the data packet included in the new transmission corresponds to multiple DRX configurations, the user uses the maximum or minimum value of the inactivity timer in these configurations to restart the timer.

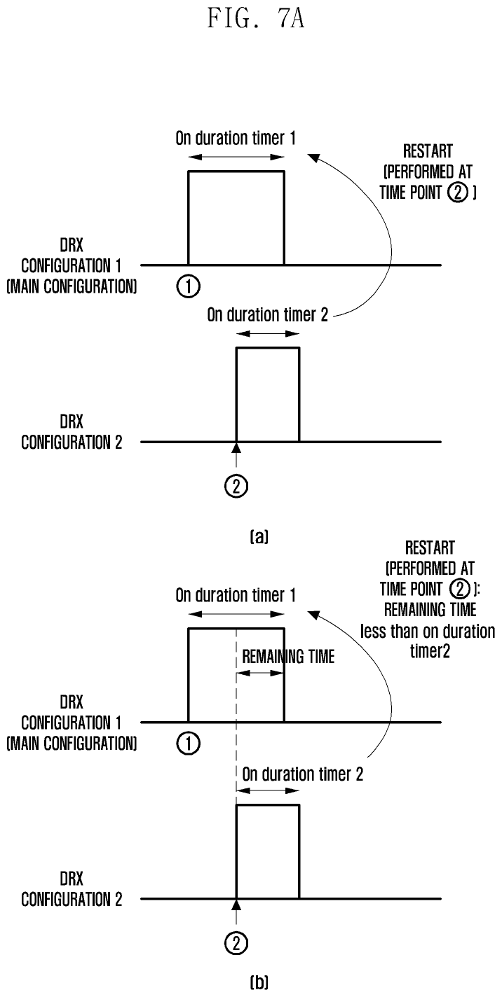

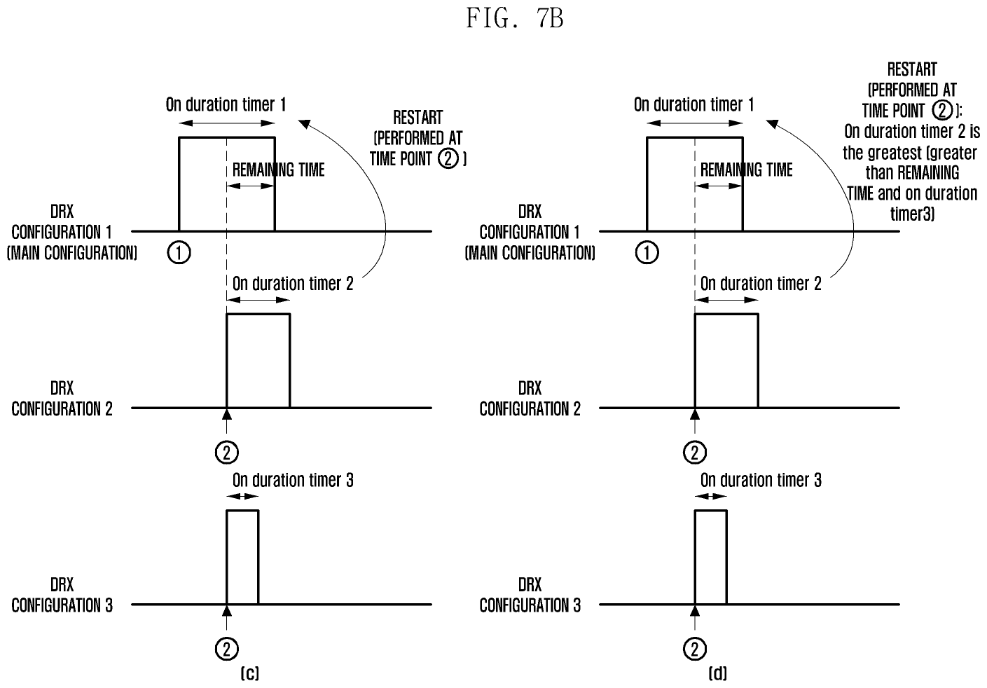

FIG. 7A and FIG. 7B: Restart of a timer. At time point 1, the user starts the On duration timer with DRX configuration 1 as the main configuration. At time point 2, the user determines that the On duration timer of DRX configuration 2 needs to be started according to a parameter in DRX configuration 2. However, the On duration timer at this time is still running. In one embodiment, as illustrated in (a) of FIG. 7A, the user may restart the On duration timer with the parameter in the DRX configuration 2. In another embodiment, as illustrated in (b) of FIG. 7A, the user may compare the remaining time of the currently running on duration timer and the setting of the on duration timer in the DRX configuration 2: if the former is greater than (or less than) the latter, the user may not restart the currently running on duration timer, and if the former is less than (or greater than) the latter, the user may restart the on duration timer with the value of the on duration timer in the DRX configuration 2. In yet another embodiment, as illustrated in (c) of FIG. 7B, if at time point 2, conditions for starting On duration timers in two DRX configurations (DRX configuration 2 and DRX configuration 3) are simultaneously met, then the user may restart the timer with the maximum or minimum value among the On duration timer of DRX configuration 2 and the On duration timer of DRX configuration 3. In yet another embodiment, as illustrated in (d) of FIG. 7B, if at time point 2, conditions for starting On duration timers in the two DRX configurations (DRX configuration 2 and DRX configuration 3) are simultaneously met, then the user determines whether to restart to time in consideration of the On duration timer of DRX configuration 2, the On duration timer of DRX configuration 3, and the maximum or minimum value of the remaining time of the currently running on duration timer (if the maximum or minimum value is the remaining time of the currently running timer, there is no need to restart the timer, otherwise, the timer is restarted with the maximum or minimum value).

### Method 3: Default DRX Configuration

In this method, the base station may provide the user with information of multiple DRX configurations, and information of each DRX configuration comprises at least one of DRX cycle, offset, On duration timer, inactivity timer, RTT timer, and retransmission timer (for details, please refer to the current DRX-Config), and the base station indicates which DRX configuration is the default configuration (or main configuration), for example, indicated through the indication information for “default configuration (or main configuration)” in the “DRX configuration information” in Step 1-1. When the user is uncertain about the DRX configuration corresponding to the transmitted data, the user uses the default configuration (or the main configuration) to perform DRX. Different from the behaviours in the above method 2, the user does not need to dynamically determine the main DRX configuration. In method 3, the main DRX configuration is fixed; while in method 2, the main DRX configuration is determined according to the configuration used when the user enters Active time. In addition, during performance of the DRX, the user exhibits the following behaviours that are different from the related art:
Behaviour 4: User updates a running timer. When the user is capable of determining the parameter that should be used (for example, when the user determines the parameter of the DRX configuration that should be used according to the service to which the received data packet belongs, for example, determines the parameter according to the identification information of the logical channel, or the identification information of the logical channel group, or the identification information of the QoS flow, the identification information of the PDU session, and the identification information of the DRB contained in the data packet), the user may update the running timer with the parameter of the determined DRX configuration. For detailed descriptions, please referring to Behaviour 2 in Method 2 for solving Technical Problem 4.
Behaviour 5: User restarts a running timer. The restarted timer may be at least one of On duration timer, inactivity timer, RTT timer, and retransmission timer. A description of this behaviour may be found in Behaviour 3 in Method 2 of solving Technical Problem 4.

### Method 4: Dynamically Indicating Configuration for Monitoring PDCCH by User

In this method, the base station informs the user of the configuration required for performing DRX monitoring (such as the time to start PDCCH monitoring, how long to monitor, what DRX configuration to use for monitoring, and what parameters to use to start a timer, etc) through an indication dynamically transmitted to the user. In order to implement this method, the base station configures various configurations for the user through Step 1-1, such as one or more of the “third configuration information”, “first timer information”, and “DRX configuration information”, and then transmits a dynamic indication to the user through Step 1-3, such as one or more of the “first time indication information”, “second time indication information”, “first configuration indication information”, and “second configuration indication information”.

The beneficial effect of the above methods is that the user may dynamically update the DRX configuration used by the user according to the configuration and/or the service corresponding to the transmitted data packet, and obtain energy saving effect and the latency effect that may adapt to the data service.

### Third Aspect: Configuration on Network Side

In order to perform the configurations of the first aspect for the user, some configurations may also need to be performed on the network side. The network side needs to have a certain grasp of the features of the XR services, so as to help the network side to perform configurations of the first aspect above. However, when the base station side adopts a CU-DU split structure or the CP-UP split structure, different entities are responsible for the configuration of the user, and interaction between different entities is required to implement the configurations of the first aspect above. In this aspect, different network-side interaction methods are provided according to different entities that have a grasp of the features of XR services.

In the following description, a CU may comprise a CU-CP and one or more CUsUPs, and may also be a single entity. When only a CU is involved in the description, the CU may be an entity, or may be a CU-CP constituting the CU, or may be a CU-UP constituting the CU.

### Method 1: Obtaining XR Service Features Through CU-UP

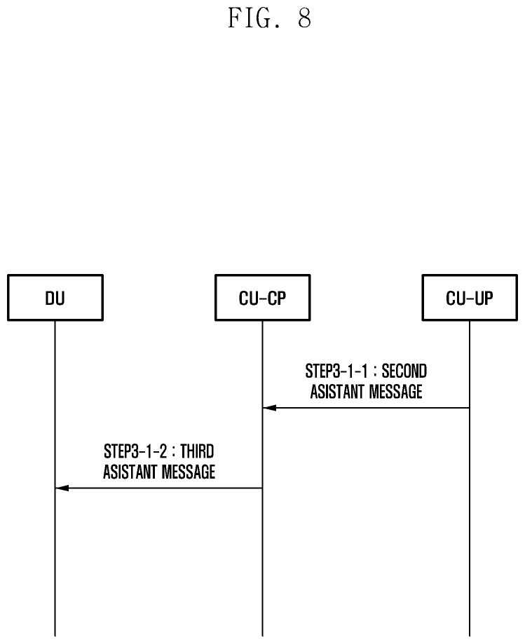

In this method, the CU-UP needs to provide the CU-CP with the characteristic information of the XR services, as illustrated in FIG. 8.

Step 3-1-1: CU-UP transmits a second assistant message to CU-CP, and the message comprises at least one of the following information:
Information related to service features, which comprises at least one of the following information for a service:
Period information
Jitter information, such as mean value of the jitter, variance of the jitter, mean square error of the jitter, etc.
Burst size information, such as average value of data size of a burst, maximum value of the data size, minimum value of the data size, variance of the data size, mean square error of the data size, etc.

The beneficial effect of this information is to help the CU-CP obtain the service features of the user, and forward the information to other nodes, thereby helping other nodes generate configuration information suitable for data reception and transmission of the user's services and reducing user energy consumption.

Step 3-1-2: CU (-CP) transmits a third assistant message to the DU, and the message comprises at least one of the following information:
Information related to service features, which comprises at least one of the following information:
Period information
Jitter information, such as mean value of the jitter, variance of the jitter, mean square error of the jitter, etc.
Burst size information, such as average value of data size of a burst, maximum value of the data size, minimum value of the data size, variance of the data size, mean square error of the data size, etc.

The beneficial effect of the information is to help the DU obtain the service features of the user, thereby helping the DU generate configuration information suitable for data reception and transmission of the user's service, and reducing the energy consumption by the user.
Recommended configuration information, which indicates a configuration recommended by the CU (-CP) according to the service features. The user may be provided with one or more sets of configurations. For a set of configurations, the information comprises at least one of the following information:
UDRX configuration information, which comprises a configuration of DRX parameters, such as DRX cycle, offset, On duration timer, inactivity timer, RTT timer, retransmission timer, etc. For details, please refer to the current DRX-Config.
Configuration information of search space, which comprises a configuration for PDCCH search space, such as period, offset, time length, DCI type, aggregation level, etc. For details, please refer to the current search space configuration.
Signal configuration information. This information may be for signals such as WUS signal or PEI signal. For details, please refer to the current WUS signal configuration or PEI signal configuration (such as period, offset, etc.).

The beneficial effect of this information is to help the DU generate configuration information suitable for data reception and transmission of the user's services, thereby reducing energy consumption by the user.

### Method 2: Obtaining XR Service Features Through DU

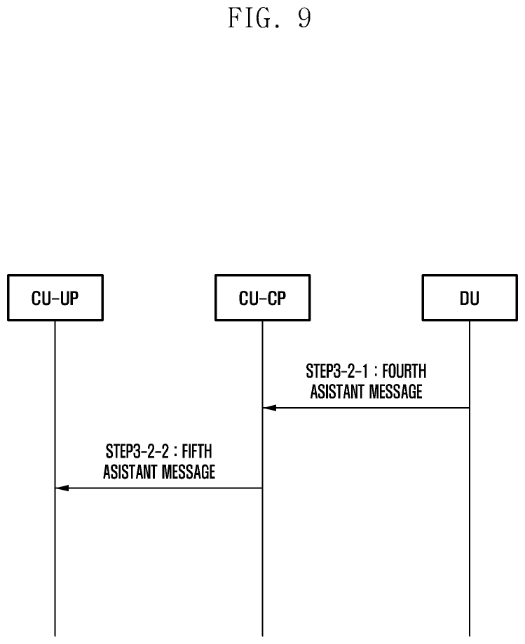

In this method, the DU generates an appropriate configuration according to the data features of the XR services, and then the DU transmits the configuration to other network entities (such as CU-UP), so that the other network entities may adjust the transmission of data according to the configuration. The method comprises the following steps, as illustrated in FIG. 9:

Step 3-2-1: DU transmits a fourthassistant message to CU (-CP), and the message comprises at least one of the following information:
Fourth configuration information, which indicates configurations generated by the DU, which may comprise one or more sets of configurations. For a set of configurations, the information comprises at least one of the following information:
DRX configuration information, which comprises a configuration of DRX parameters, such as DRX cycle, offset, On duration timer, inactivity timer, RTT timer, retransmission timer, etc. For details, please refer to the current DRX-Config.
Configuration information of search space, which comprises a configuration for PDCCH search space, such as period, offset, time length, DCI type, aggregation level, etc. For details, please refer to the current search space configuration.
Signal configuration information. This information may be for signals such as WUS signal or PEI signal. For details, please refer to the current WUS signal configuration or PEI signal configuration (such as period, offset, etc.).

The beneficial effect of this information is to help the CU (-CP) obtain configurations related to the user's services, and forward the configurations to other nodes, thereby reducing energy consumption by the user.

Step 3-2-2: CU-CP transmits a fifth assistant message to CU-UP, and the message comprises at least one of the following information:
Fifth configuration information, which indicates configurations generated by the DU, which may comprise one or more sets of configurations, and for a set of configurations, the information comprises at least one of the following information:
DRX configuration information, which comprises a configuration of DRX parameters, such as DRX cycle, offset, On duration timer, inactivity timer, RTT timer, retransmission timer, etc. For details, please refer to the current DRX-Config.
   Configuration information of search space, which comprises a configuration for PDCCH search space, such as period, offset, time length, DCI type, aggregation level, etc. For details, please refer to the current search space configuration.
   Signal configuration information. This information may be for signals such as WUS signal or PEI signal. For details, please refer to the current WUS signal configuration or PEI signal configuration (such as period, offset, etc.).

After receiving the above information, the CU-UP performs the transmission of data according to the above information. For example, before the user starts PDCCH monitoring, the data is transmitted to the DU to reduce the energy consumption by the user.

### Method 3: Obtaining Features of XR Services Through CU or CU-CP

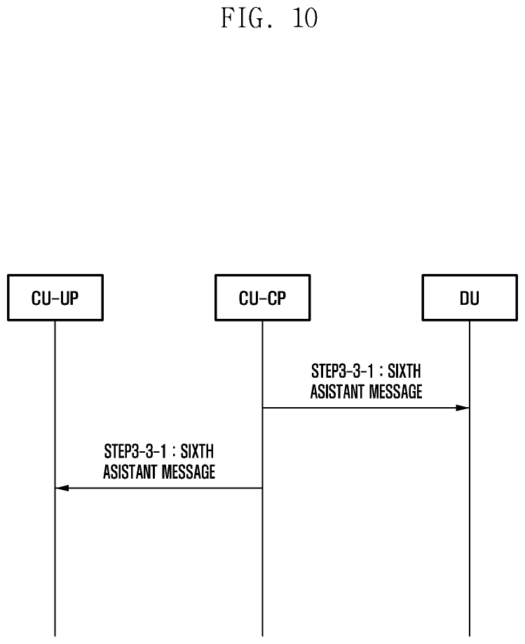

In this method, the CU (-CP) obtains the data features of the XR services (in one embodiment, the CU (-CP) obtains the information from the core network, and in another embodiment the CU (-CP) obtains the information from the UE, as obtained by Step 1-0 of the first aspect above), and generate a suitable configuration, thereby transmitting the configuration to other entities. The method comprises the following steps, as illustrated in FIG. 10:

Step 3-3-1: CU (-CP) transmits a sixth assistant message to DU and/or CU-UP, and the message comprises at least one of the following information:
Sixth configuration information, which indicates configurations generated by the DU, which may comprise one or more sets of configurations. For a set of configurations, the information comprises at least one of the following information:
DRX configuration information, which comprises a configuration of DRX parameters, such as DRX cycle, offset, On duration timer, inactivity timer, RTT timer, retransmission timer, etc. For details, please refer to the current DRX-Config.
Configuration information of search space, which comprises a configuration for PDCCH search space, such as period, offset, time length, DCI type, aggregation level, etc. For details, please refer to the current search space configuration.
Signal configuration information. This information may be for signals such as WUS signal or PEI signal. For details, please refer to the current WUS signal configuration or PEI signal configuration (such as period, offset, etc.).

After receiving the above information, the CU-UP/DU performs transmission of data according to the above information. For example, before the user starts PDCCH monitoring, the data is transmitted to the DU to reduce the energy consumption by the user.

In the above methods, the second assistant message may be a bearer context modification required/response message of the E1 interface or may be other messages.

The third assistant message may be a UE context setup/modification request message of the F1 interface, or may be other messages.

The fourth assistant message may be a UE context modification response/required message of the F1 interface, or may be other messages.

The fifth assistant message may be a bearer context setup/modification request message of the E1 interface, or may be other messages.

The sixth assistant message may be a UE context setup/modification request message of the F1 interface, or a bearer context setup/modification request message of the E1 interface, or may be other messages.

The beneficial effect of the above processes is that: the network side may obtain the features of the XR services, and generate configurations for reception of signals by the user (such as monitoring PDCCH) suitable for the XR services, and adjust transmission of data packets according to the configurations, thereby saving the energy consumption by the user, and reducing the latency of transmission of the XR services.

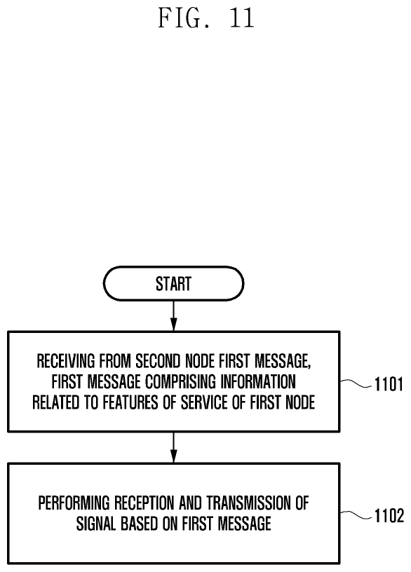

FIG. 11 illustrates a method performed by a first node according to an embodiment of the present disclosure. In the method, in Step 1110, the first node receives from a second node a first message determined based on service features of the first node, wherein the first message comprises information related to the service features of the first node.

In Step 1120, the first node performs reception and transmission of a signal based on the first message.

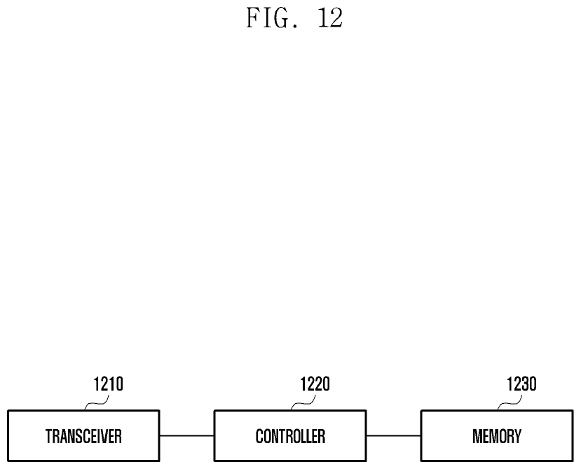

FIG. 12 is a schematic diagram of a user equipment (UE) according to an embodiment of the disclosure.

Referring to FIG. 12, the UE may include a transceiver 1210, a controller 1220, and a storage unit 1230. In the embodiment, the controller 1220 may be defined as a circuit, an application-specific integrated circuit, or at least one processor.

The transceiver 1210 may transmit/receive signals to/from other network entities. The controller 1220 may control overall operations of the UE according to the embodiment proposed in the disclosure. The storage unit 1230 may store at least one piece of information transmitted/received through the transceiver 1210 and information produced through the controller 1220.

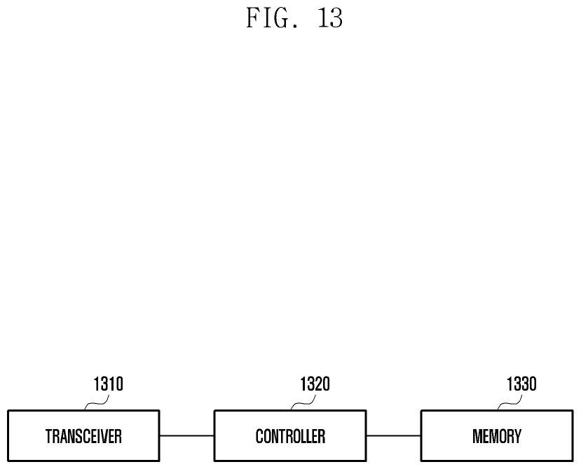

FIG. 13 is a schematic diagram of a network according to an embodiment of the disclosure. The network may correspond to the RAN node in the respective embodiments.

Referring to FIG. 13, the base station may include a transceiver 1310, a controller 1320, and a storage unit 1330. In the embodiment, the controller 1320 may be defined as a circuit, an application-specific integrated circuit, or at least one processor.

The transceiver 1310 may transmit/receive signals to/from other network entities. The controller 1320 may control overall operations of the base station according to the embodiment proposed in the disclosure. The storage unit 1330 may store at least one piece of information transmitted/received through the transceiver 1310 and information produced through the controller 1320.

In various embodiments, the first message comprises at least one of the following information: transmission period information, which is used to indicate period-related information related to the first node performing the reception and transmission of data and/or signal; first information, which is used to indicate configuration information related to the first node performing the reception and transmission of data and/or signal; third configuration information, which is used to indicate configuration information related to the first node performing PDCCH monitoring performed; first timer information, which is used to indicate configuration information related to a first timer, the first timer being the time when the first node performs the reception and transmission of data and/or signal or the time of switching the configuration; second timer information, which is used to indicate configuration information related to a second timer, the second timer being the time using the configuration when the first node performs the reception and transmission of data and/or signal; and configuration information for DRX, which is used to indicate configuration information related to the first node performing the DRX.

In various embodiments, the transmission period information comprises at least one of the following information: first period information, which is used to indicate information related to a first period, the first period being a period corresponding to the first node performing the reception and transmission of data and/or signal; first offset information, which is used to indicate offset information related to the first period; second period information, which is used to indicate information related to a second period used within the first period; and second offset information, which is used to indicate offset information related to the second period.

In various embodiments, the first information comprises at least one of the following information: signal monitoring configuration information, which is used to indicate configuration information related to monitoring a signal; trigger indication information, which is used to indicate a time when the first node triggers and/or starts reception and transmission of data and/or signal configured by the signal monitoring configuration information; and trigger timer information, which is used to indicate a timer related to triggering and/or starting reception and transmission of data and/or signal configured by the signal monitoring configuration information.

In various embodiments, the third configuration information comprises multiple sets of configuration information, wherein each set of configuration information comprises at least one of the following information: an offset time for monitoring start; a time length for monitoring; and first state indication information, which is used to indicate whether the set of configuration information is in an active state; and/or the third configuration information comprises second state indication information, which indicates whether one or more sets of configuration information in the multiple sets of configuration information are in an active state(s).

In various embodiments, the first timer information comprises one or more configurations for length information, and for each configuration of length information, the first timer information comprises at least one of the following information: a first timer length information; first condition information, which is used to indicate condition information related to starting or restarting the first timer; decrement step size information, which is used to indicate information related to decrement of a timer initial length set when starting or restarting the first timer and/or a step size of a timer when decrementing; first applicability information, which is used to indicate information related to an applicable scope(s) of one or more pieces of information included in the first timer information; and a third state indication information, which is used to indicate whether a configuration for the length information is in an active state; and/or the first timer information comprises fourth state indication information, which is used to indicate whether one or more sets of configurations for length information among multiple sets of configurations for length information are in an active state(s); and/or the second timer information comprises at least one of the following information: second timer length information; second applicability information, which is used to indicate information related to an applicable scope(s) of one or more pieces of information included in the second timer information; and state indication information, which is used to indicate whether the second timer information is in an active state.

In various embodiments, the configuration information for DRX comprises one or more sets of DRX-related configuration information, and each set of DRX-related configuration information comprises at least one of the following information: first configured DRX information, comprising a configuration of parameters for performing DRX; applicable scope information, which indicates an applicable scope of the first configured DRX information; fifth state indication information, which is used to indicate whether the set of configuration is in an active state; and default configuration indication information, which indicates whether the first configured DRX information is a default configuration, and/or the DRX configuration information comprises sixth state indication information, which indicates whether one or more sets of DRX-related configuration information among multiple sets of DRX-related configuration information are in an active state(s).

In various embodiments, the first node receives a second message from the second node, wherein the second message comprises information related to service features of the first node; wherein performing the reception and transmission of data and/or signal based on the first message comprises: the first node performing the reception and transmission of data and/or signal based on the first message and the second message.

In various embodiments, the second message comprises at least one of the following information: first start indication information, which is used to indicate whether the first node starts a configuration related to a specific search space; first stop indication information, which is used to indicate whether the first node stops the reception and transmission of data and/or signal; first time indication information, which is used to indicate information related to the first node starting or restarting a timer; second time indication information, which is used to indicate information related to the first node starting or restarting a plurality of timers; first configuration indication information, which is used to indicate a configuration related to the first node performing the DRX; and second configuration indication information, which is used to indicate a configuration related to the first node performing the PDCCH monitoring.

In one embodiment, the method further comprises: the first node transmitting to the second node at least one of information related to service features of the first node and configuration information that the first node expects regarding the reception and transmission of data and/or signal.

In various embodiments, the signal comprises at least one of a PDCCH, a wake-up signal (WUS), and a paging early indication (PEI) signal.

According to another aspect of the present disclosure, there is provided a node device in a wireless communication system, comprising: a transceiver; and a processor coupled to the transceiver and configured to perform the above method.

According to another aspect of the present disclosure, there is provided a method performed by a second node in a wireless communication system, comprising: determining a first message based on information related to service features of a first node; and transmitting the first message to the first node.

In various embodiments, the first message comprises at least one of the following information: transmission period information, which is used to indicate period-related information related to the first node performing the reception and transmission of data and/or signal; first information, which is used to indicate configuration information related to the first node performing the reception and transmission of data and/or signal; third configuration information, which is used to indicate configuration information related to the first node performing PDCCH monitoring performed; first timer information, which is used to indicate configuration information related to a first timer, the first timer being the time when the first node performs the reception and transmission of data and/or signal or the time of switching the configuration; second timer information, which is used to indicate configuration information related to a second timer, the second timer being the time using the configuration when the first node performs the reception and transmission of data and/or signal; and configuration information for DRX, which is used to indicate configuration information related to the first node performing the DRX.

In various embodiments, the transmission period information comprises at least one of the following information: first period information, which is used to indicate information related to a first period, the first period being a period corresponding to the first node performing the reception and transmission of data and/or signal; first offset information, which is used to indicate offset information related to the first period; second period information, which is used to indicate information related to a second period used within the first period; and second offset information, which is used to indicate offset information related to the second period.

In various embodiments, the first information comprises at least one of the following information: signal monitoring configuration information, which is used to indicate configuration information related to monitoring a signal; trigger indication information, which is used to indicate a time when the first node triggers and/or starts reception and transmission of data and/or signal configured by the signal monitoring configuration information; and trigger timer information, which is used to indicate a timer related to triggering and/or starting reception and transmission of data and/or signal configured by the signal monitoring configuration information.

In various embodiments, the third configuration information comprises multiple sets of configuration information, wherein each set of configuration information comprises at least one of the following information: an offset time for monitoring start; a time length for monitoring; and first state indication information, which is used to indicate whether the set of configuration information is in an active state; and/or the third configuration information comprises second state indication information, which indicates whether one or more sets of configuration information in the multiple sets of configuration information are in an active state(s).

In various embodiments, the first timer information comprises one or more configurations for length information, and for each configuration of length information, the first timer information comprises at least one of the following information: a first timer length information; first condition information, which is used to indicate condition information related to starting or restarting the first timer; decrement step size information, which is used to indicate information related to decrement of a timer initial length set when starting or restarting the first timer and/or a step size of a timer when decrementing; first applicability information, which is used to indicate information related to an applicable scope(s) of one or more pieces of information included in the first timer information; and a third state indication information, which is used to indicate whether a configuration for the length information is in an active state; and/or the first timer information comprises fourth state indication information, which is used to indicate whether one or more sets of configurations for length information among multiple sets of configurations for length information are in an active state(s); and/or the second timer information comprises at least one of the following information: second timer length information; second applicability information, which is used to indicate information related to an applicable scope(s) of one or more pieces of information included in the second timer information; and state indication information, which is used to indicate whether the second timer information is in an active state.

In various embodiments, the configuration information for DRX comprises one or more sets of DRX-related configuration information, and each set of DRX-related configuration information comprises at least one of the following information: first configured DRX information, comprising a configuration of parameters for performing DRX; applicable scope information, which indicates an applicable scope of the first configured DRX information; fifth state indication information, which is used to indicate whether the set of configuration is in an active state; and default configuration indication information, which indicates whether the first configured DRX information is a default configuration, and/or the DRX configuration information comprises sixth state indication information, which indicates whether one or more sets of DRX-related configuration information among multiple sets of DRX-related configuration information are in an active state(s).

In a further embodiment, the method further comprises: receiving information related to the service features of the first node from a core network device or a user equipment;

In a further embodiment, the method further comprises: determining a second message based on information related to the service features of the first node; and transmitting the second message to the first node.

In various embodiments, the second message comprises at least one of the following information: first starting indication information, which is used to indicate whether the first node starts a configuration related to a specific search space; first stop indication information, which is used to indicate whether the first node stops the reception and transmission of data and/or signal; first time indication information, which is used to indicate information related to the first node starting or restarting a timer; second time indication information, which is used to indicate information related to the first node starting or restarting a plurality of timers; first configuration indication information, which is used to indicate a configuration related to the first node performing the DRX; and second configuration indication information, which is used to indicate a configuration related to the first node performing the PDCCH monitoring.

In a further embodiment, the method further comprises receiving, from the first node, configuration information that the first node expects regarding the reception and transmission of data and/or signal.

In various embodiments, the signal comprises a PDCCH or a wake-up signal (WUS) or a paging early indication (PEI) signal.

According to another aspect of the present disclosure, there is provided a node device in a wireless communication system, comprising: a transceiver configured to transmit and receive a signal; and a controller coupled to the transceiver and configured to perform operations in the above method.

In various embodiments, the node device is a base station or a centralized unit user plane CU-UP node of a base station or a centralized unit control plane CU-CP node of the base station.

According to another aspect of the present disclosure, there is provided a method performed by a fourth node in a wireless communication system, comprising: determining an assistant message based on information related to service features of a first node; and transmitting the assistant message to a fifth node.

In a further embodiment, the method further comprises: the fourth node receiving the information related to the service features of the first node from a core network device or a user equipment or a centralized unit user plane CU-UP of a base station.

In various embodiments, the fourth node is a centralized unit of a base station or a centralized unit control plane CU-CP of the base station, and the fifth node is a distributed unit DU of the base station or a centralized unit user plane CU-UP of the base station.

According to another aspect of the present disclosure, there is provided a method performed by a fifth node in a wireless communication system, comprising: receiving an assistant message from a fourth node, the assistant message being determined based on information related to service features of a first node; performing reception and transmission of data and/or signal with the first node based on an assistant message related to service features of a user equipment; and/or determining a first message and/or a second message based on the assistant message related to the service features of the user equipment and transmitting the first message and/or the second message is to the first node.

According to another aspect of the present disclosure, there is provided a node device in a wireless communication system, comprising: a transceiver configured to transmit and receive a signal; and a controller coupled to the transceiver and configured to perform a method as follows: determining an assistant message based on information related to service features of a first node; and transmitting the assistant message to a fifth node.

In a further embodiment, the node device receives the information related to the service features of the first node from a core network device or a user equipment or a centralized unit user plane CU-UP of a base station.

In a further embodiment, the node device is a centralized unit of a base station or a centralized unit control plane CU-CP of the base station, and the fifth node is a distributed unit DU of the base station or a centralized unit user plane CU-UP of the base station.

According to another aspect of the present disclosure, there is provided a node device in a wireless communication system, comprising: a transceiver configured to transmit and receive a signal; and a controller coupled to the transceiver and configured to perform a method as follows: receiving an assistant message from a fourth node, the assistant message being determined based on information related to service features of a first node; performing reception and transmission of data and/or signal with the first node based on an assistant message related to service features of a user equipment; and/or determining a first message and/or a second message based on the assistant message related to the service features of the user equipment and transmitting the first message and/or the second message is to the first node.

Those skilled in the art will understand that the above-described illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily appreciated that the various aspects of the disclosed invention, as generally described herein and illustrated in the accompanying drawings, may be arranged, substituted, combined, separated, and designed in various different configurations, all of which are herein was envisaged.

Those of skill in the art will understand that the various illustrative logical blocks, modules, circuits, and steps described herein can be implemented as hardware, software, or combinations of both. To clearly illustrate this interchangeability of hardware and software, various illustrative components, blocks, modules, circuits, and steps have been described above generally in terms of their function sets. Whether such a feature set is implemented as hardware or software depends on the specific application and design constraints imposed on the overall system. Those skilled in the art may implement the described function sets in varying ways for each particular application, but such design decisions should not be interpreted as causing a departure from the scope of this application.

The various illustrative logical blocks, modules, and circuits described in this application may be implemented or performed in general-purpose processors, digital signal processors (DSPs), application specific integrated circuits (ASICs), field programmable gate arrays (FPGAs) or other programmable logic devices, discrete gates or transistor logisc, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, removable disk, or any other form of storage medium known in the art. An exemplary storage medium is coupled to the processor such the processor can read information from, and write information to, the storage medium. In the alternative, the storage medium may be integrated into the processor. The processor and storage medium may reside in the ASIC. The ASIC may reside in the user terminal. In the alternative, the processor and storage medium may reside in the user terminal as discrete components.

In one or more exemplary designs, the functions may be implemented in hardware, software, firmware, or any combination thereof. If implemented in software, the functions may be stored on or transmitted over as one or more instructions or code in a computer-readable medium. Computer-readable media comprises both computer storage media and communication media including any medium that facilitates transfer of a computer program from one place to another. A storage medium can be any available medium that can be accessed by a general purpose or special purpose computer.

The above description is only exemplary embodiments of the present invention and is not intended to limit the scope of the present invention, which is defined by the appended claims.

1.-15. (canceled)

16. A method performed by a user equipment (UE) in a wireless communication system, the method comprising:
transmitting, to a base station, a first message to provide uplink traffic information; and
receiving, from the base station, a second message including a discontinuous reception (DRX) configuration,
wherein the first message includes at least one of jitter information and traffic periodicity information.

17. The method of claim 16,
wherein in case that the base station consists of a central unit (CU) and a distributed unit (DU), the at least one of the jitter information and the traffic periodicity information transmitted from the UE is transmitted by the CU to the DU.

18. The method of claim 16,
wherein the first message is associated with a UE assistance message, and
wherein the second message is associated with a radio resource control (RRC) reconfiguration message.

19. The method of claim 17,
wherein a message transmitted from the CU to the DU is associated with a UE CONTEXT MODIFICATION REQUEST, and
wherein the message includes information on an CU-DU RRC.

20. A method performed by a base station in a wireless communication system, the method comprising:
receiving, from a user equipment (UE), a first message to provide uplink traffic information; and
transmitting, to the UE, a second message including a discontinuous reception (DRX) configuration,
wherein the first message includes at least one of jitter information and traffic periodicity information.

21. The method of claim 20, wherein in case that the base station consists of a central unit (CU) and a distributed unit (DU), the at least one of the jitter information and the traffic periodicity information received from the UE is transmitted by the CU to the DU.

22. The method of claim 20,
wherein the first message is associated with a UE assistance message, and
wherein the second message is associated with a radio resource control (RRC) reconfiguration message.

23. The method of claim 21,
wherein a message transmitted from the CU to the DU is associated with a UE CONTEXT MODIFICATION REQUEST, and
wherein the message includes information on an CU-DU RRC.

24. A user equipment (UE) in a wireless communication system, comprising:
a transceiver; and
a processor coupled to the transceiver and configured to:
transmit, to a base station, a first message to provide uplink traffic information, and
receive, from the base station, a second message including a discontinuous reception (DRX) configuration,
wherein the first message includes at least one of jitter information and traffic periodicity information.

25. The UE of claim 24, wherein in case that the base station consists of a central unit (CU) and a distributed unit (DU), the at least one of the jitter information and the traffic periodicity information transmitted from the UE is transmitted by the CU to the DU.

26. The UE of claim 24,
wherein the first message is associated with a UE assistance message, and
wherein the second message is associated with a radio resource control (RRC) reconfiguration message.

27. The UE of claim 25,
wherein a message transmitted from the CU to the DU is associated with a UE CONTEXT MODIFICATION REQUEST, and
wherein the message includes information on an CU-DU RRC.

28. A base station in a wireless communication system, comprising:
a transceiver; and
a processor coupled to the transceiver and configured to:
receive, from a user equipment (UE), a first message to provide uplink traffic information, and
transmit, to the UE, a second message including a discontinuous reception (DRX) configuration,
wherein the first message includes at least one of jitter information and traffic periodicity information.

29. The base station of claim 28, wherein in case that the base station consists of a central unit (CU) and a distributed unit (DU), the at least one of the jitter information and the traffic periodicity information received from the UE is transmitted by the CU to the DU.

30. The base station of claim 28,
wherein the first message is associated with a UE assistance message, and
wherein the second message is associated with a radio resource control (RRC) reconfiguration message.
